(19) United States
(12) Patent Application Publication
(10) Pub. No.: US 2014/0025444 A1
(43) Pub. Date: Jan. 23, 2014

(54) Universal Toll Tag Device and Systems and Methods to Automate Toll Payments

(71) Applicant: PAYURTOLL LLC, Loveland, OH (US)

(72) Inventor: Mark Alan Willis, Loveland, OH (US)

(73) Assignee: Payurtoll LLC, Loveland, OH (US)

(21) Appl. No.: 13/783,872

(22) Filed: Mar. 4, 2013

Related U.S. Application Data
(60) Provisional application No. 61/674,441, filed on Jul. 23, 2012.

(51) Int. Cl. G06Q 20/32

(52) U.S. Cl. CPC G06Q 20/3272
USPC 705/13

(57) ABSTRACT

A system and method for processing toll-based payment transactions via a mobile device is described. The mobile device may include a processor configuring the mobile device to: receive a GPS location of the mobile device; receive location information associated with at least one tolling location; determine whether the mobile device is within a predetermined distance of the at least one tolling location based on the GPS location of the mobile device; record a tolling event when the mobile device is within the predetermined distance of the at least one tolling location; and communicate the tolling event to a server for processing a toll-based transaction.

### CROSS-REFERENCE TO RELATED APPLICATIONS

This application is related to U.S. Provisional Application Ser. No. 61/674,441, filed on Jul. 23, 2012, and entitled “Universal Toll Tag Device and Software to Automate Toll Payments Using a Cell Phone Attached Device or an Application using Software Defined Radio,” the entirety of which is herein incorporated by reference.

### FIELD OF THE INVENTION

The invention relates to processing toll-based payment transactions. In particular, the invention relates to processing toll-based payment transactions using a mobile device and/or a toll tag device communicably attached to or incorporated into a mobile device.

### BACKGROUND OF THE INVENTION

Typically, toll payment across different states or regions is managed via a separate toll booth payment system for each state or region. Thus, a toll booth manager has to create and manage these separate toll booth payment system for different states or regions, resulting in increased staffing and labor costs. Generally, a transceiver is attached to a motor vehicle (typically attached to the windshield of motor vehicles) for purposes of toll payment.

What is needed is a device, such as a mobile device, that is able to communicate or work with various toll booths in different states, regions, countries, etc. and across different toll booth payment systems. Also, what is needed is a mobile device with which a user pays tolls without the need for the transceiver attached to the motor vehicle.

### SUMMARY OF THE INVENTION

Various systems, computer program products, and methods for processing toll-based payment transactions via mobile devices are provided. According to various implementations of the invention, a mobile device for processing a toll-based payment transaction may include a processor configuring a mobile device to: receive a first audio signal from a toll tag device communicably coupled to the mobile device, where the audio signal comprises a toll booth identifier identifying a toll plaza; retrieve, from a memory device, user information in response to the first audio signal; convert the user information to a second audio signal; and communicate the second audio signal to the toll tag device for transmission to the toll plaza identified by the toll booth identifier.

According to various implementations of the invention, a toll tag device for processing a toll-based payment transaction may include a processor configuring a toll tag device to: tune to an RF receive frequency, where the RF receive frequency is identified based on a current GPS location of a mobile device, wherein the toll tag device is communicably coupled to the mobile device; receive an RF signal from a toll booth radio device, wherein the RF signal comprises a toll booth identifier identifying a toll plaza; convert the RF signal to an audio signal; and communicate the audio signal to a mobile device.

According to various implementations of the invention, a mobile device for processing toll-based payment transactions may include a processor configuring the mobile device to: receive a GPS location of the mobile device; receive location information associated with at least one tolling location; determine whether the mobile device is within a predetermined distance of the at least one tolling location based on the GPS location of the mobile device; record a tolling event when the mobile device is within the predetermined distance of the at least one tolling location; and communicate the tolling event to a server for processing a toll-based transaction.

### BRIEF DESCRIPTION OF THE DRAWINGS

FIG. 1 is a block diagram illustrating an example of a system for processing toll-based payment transactions according to various implementations of the invention.

FIGS. 2A-2B are block diagrams illustrating an exemplary toll tag device and mobile device, according to various implementations of the invention.

FIG. 3 is a flow diagram illustrating an example high-level operation of a toll tag device, according to various aspects of the invention.

FIG. 4 is a flow diagram illustrating an example of a reception process of the toll tag device, according to various implementations of the invention.

FIG. 5 is a flow diagram illustrating an example of a transmission process of the toll tag device, according to various implementations of the invention.

FIG. 6 is a flow diagram illustrating an example of a process of the mobile device, according to various implementations of the invention.

FIG. 7 is diagram illustrating an example flow of data among various entities involved in the processing of toll-based payment transactions, according to various implementations of the invention.

FIG. 8 is a diagram illustrating an example flow of data among various entities for communicating toll coordinate information, according to various implementations of the invention.

FIG. 9 is a diagram illustrating an example flow of data among various entities for determining violators, according to various implementations of the invention.

FIG. 10 is a block diagram illustrating example components of a wireless receiver implemented in a mobile device 110, according to various implementations of the invention.

FIGS. 11A-11Q illustrate exemplary screenshots depicting various interfaces associated with a mobile device, according to various implementations of the invention.

FIG. 12 is a diagram illustrating an example flow of a process of a mobile device according to various implementations of the invention.

### DETAILED DESCRIPTION

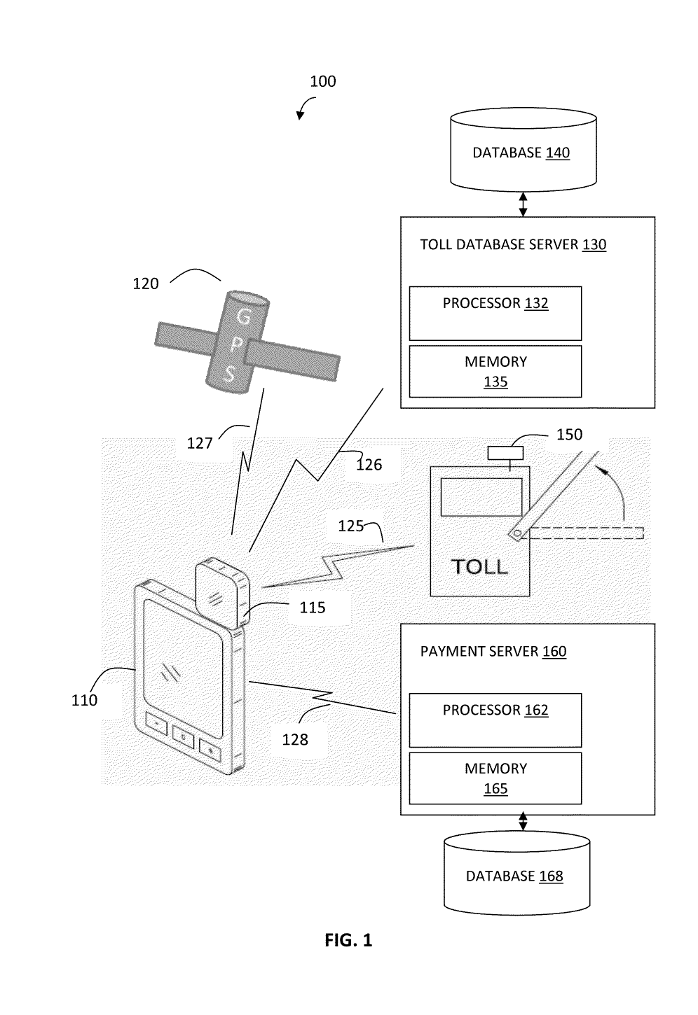

According to various implementations of the invention, various systems and methods may facilitate toll-based payment transactions via mobile devices. FIG. 1 is a block diagram illustrating a system 100 for processing toll-based payment transactions via mobile devices, according to various implementations of the invention. In some implementations of the invention, system 100 may be used to process toll-based payment transactions via a toll tag device 115 removably attached to the mobile device 110. A toll tag device 115 may include a transponder that transmits and receives radio signals. A toll tag device 115 may communicate with different toll booth radio devices (illustrated in FIG. 1 as toll booth radio device 150). A toll booth radio device 150 may include a radio device attached or installed on a toll booth or another structure of a toll booth plaza. A toll booth radio device 150 may be positioned on, near or above every toll lane of the toll booth plaza. The toll booth radio device 150 may include an antenna that emits radio frequencies. In some implementations, the toll booth radio device 150 may be mounted on an overhead gantry structure (or other overhead structure) that spans toll lanes on a toll road (e.g., in so-called “open road tolling” systems). As would be appreciated, a number of radio devices 150 may be utilized at a given toll booth plaza or other tolling location.

In some implementations, a toll tag device 115 transmits and receives RF signals to and from a toll booth radio device 150 based on a GPS location of the mobile device 110. In some implementations, the mobile device 110 may be configured by instructions such as a mobile application (not otherwise illustrated in FIG. 1) to determine a GPS location of the mobile device, to determine an appropriate toll booth payment system based on the determined GPS location, and to configure toll tag device 115 based on the determined toll booth payment system in order to communicate with the determined toll booth payment system for purposes of toll-based payment transaction. The toll tag device 115 may convert the RF signals received from the toll booth radio device 150 into audio signals for mobile device consumption. The mobile application may interpret the audio signals and communicate with the toll booth radio device 150 or a separate remote payment server 160 for the purposes of processing a toll-based payment transaction.

In some implementations, the functionality of the toll tag device 115 may be incorporated directly into the mobile device 110. In some implementations existing components of the mobile device 110 may be leveraged to provide the functionality of the toll tag device 115. In some implementations, the mobile device may include a wireless receiver that is configured to generate and process the RF signals from/to the toll booth radio device 150. In these implementations, the mobile device 110 may itself act as a toll tag device without the need for an external toll tag device 115 attached to the mobile device 110.

According to various implementations of the invention, a toll-based payment transaction may include, for instance, a payment transaction which involves electronically transferring funds or money from one account to another or transferring funds or money from a financial account for the purposes of paying tolls.

In some implementations, a user is a person or other entity that is a payment cardholder, a user using the system to make a toll-based payment, a user using the system to transfer funds, and/or other person or entity using the system to process a toll-based payment transaction. Those having skill in the art will appreciate that the invention described herein may work with various system configurations.

According to various implementations of the invention, system 100 may include, but is not limited to, a mobile device 110, a toll tag device 115, a toll booth radio device 150, a toll database server 130, and a payment server 160. In some implementations of the invention, mobile device 110 and toll database server 130 may be communicably coupled to one another via a network or link 126. In some implementations of the invention, mobile device 110 and payment server 160 may be communicably coupled to one another via a network or link 128. Network 126 or 128 may include a Local Area Network, a Wide Area Network, a cellular communications network, a Public Switched Telephone Network, and/or other network or combination of networks.

In some implementations, toll tag device 115 and/or mobile device 110 may be communicably coupled to toll booth radio device 150 via a network or link 125. In some implementations, toll tag device 115 and/or mobile device 110 may be communicably coupled to GPS satellite 120 via a network or link 127. Network 125 or 127 may include a radio communication network, or wireless network or combination or wireless networks.

According to various implementations of the invention, mobile device 110 may include a mobile computing/processing device such as a wireless phone, a personal digital assistant, a smart phone, a tablet computing device, and/or other portable computing device that may be utilized to communicate information with toll tag device 115, toll database server 130, and/or payment server 160. In some implementations, mobile device 110 may be used to perform toll-based payment transactions.

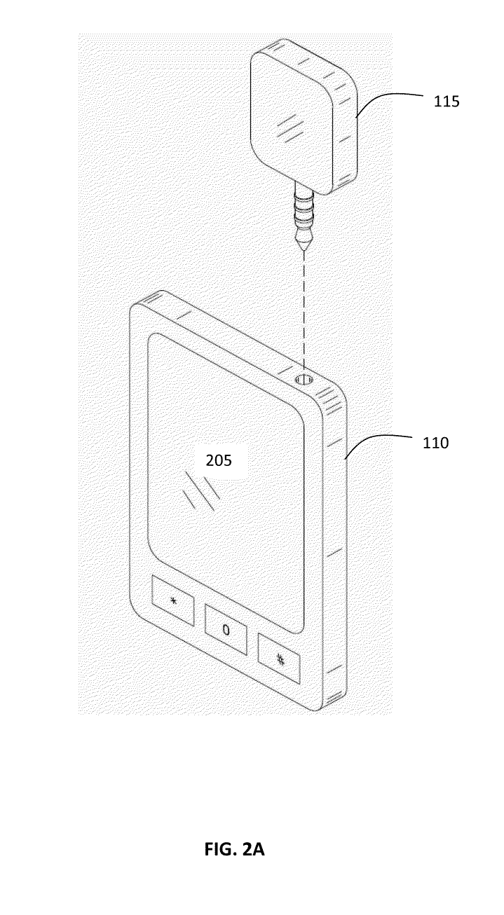

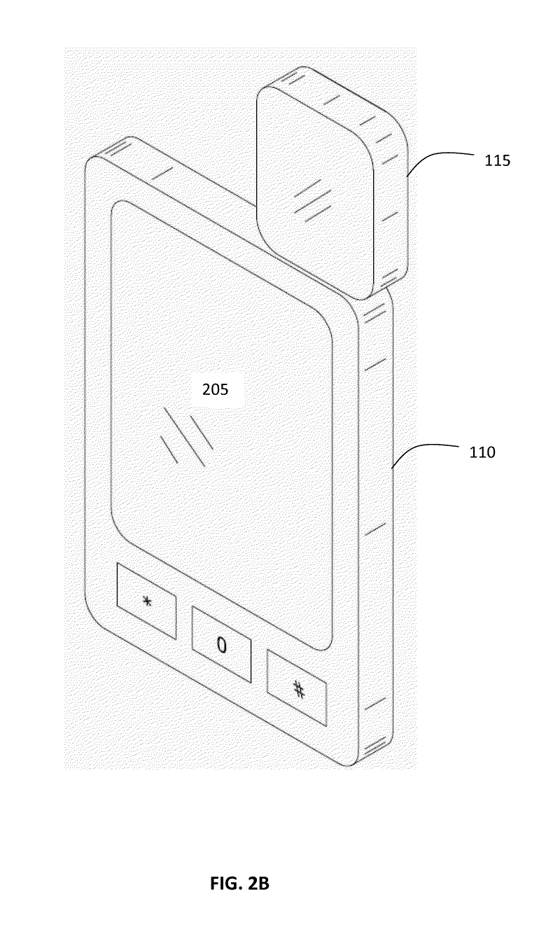

In some implementations, toll tag device 115 and mobile device 110 may be communicably coupled to one another via a bi-directional link, which may include a wired link (such as via Universal Serial Bus, headphone/multi-function jack, or other wired link). In some implementations, toll tag device 115 may be connected to or plugged in the mobile device 110. In some implementations, the toll tag device 115 may be plugged into a headphone/audio jack of the mobile device 110, as shown in FIGS. 2A and 2B, for example. In some implementations, the audio jack may include a 4 pin audio jack with left, right audio out, ground and microphone pins. Other types of audio jacks may be used as would be appreciated.

Referring to FIG. 2 generally, mobile device 110 may include a user interface (illustrated in FIGS. 2A-2B as interface 205). A user or other entity may download various instructions such as a mobile application (such as, a mobile toll payment application) to the mobile device 110. The instructions when executed by a processor/microprocessor (not illustrated in FIGS. 2A-2B) of the mobile device 110 causes the processor/microprocessor to generate interface 205, which may be configured to prompt for and receive customer information, provide location information, provide toll road information, toll booth/plaza information associated with a particular toll road, payment information, and/or other information. In some implementations of the invention, the mobile application may facilitate communication between the mobile device 110, toll database server 130 and payment server 160, thereby allowing the toll tag device 115 and/or mobile device 110 to be used to process a toll-based payment transaction.

Referring back to FIG. 1, in some implementations of the invention, toll database server 130 may facilitate the mobile application to be downloaded to mobile device 110; in some implementations of the invention, payment server 160 or other source for mobile application may facilitate the mobile application to be downloaded to mobile device 110. For example, the instructions associated with the mobile application may be stored within memory 135 or other accessible memory location of toll database server 130, payment server 160 or other source. In some implementations, the mobile application may be downloaded in response to the toll tag device 115 being attached to (plugged in) the mobile device 110.

In some implementations, mobile device 110 may include a GPS receiver (not otherwise illustrated in FIG. 1) that is configured to receive signals from GPS satellites (illustrated in FIG. 1 as GPS satellite 120) and determine the current GPS location (latitude, longitude, and elevation) or current coordinates of the mobile device 110. In some implementations, the GPS receive may receive differential GPS signals and may determine a differentially corrected location of the mobile device 110, as would be appreciated. In some implementations, mobile device 110 may include an assisted GPS system (AGPS) to determine the current GPS location of the mobile device 110, as would be appreciated. In some implementations, mobile device 110 may utilize various ground-based systems to determine the location of the mobile device 110, based on, for example, positions of cell towers or positions of other known transmitters as are generally well understood. In some implementations, mobile device 110 may utilize various combinations of any of the foregoing systems for determining the location of the mobile device 110 as would be appreciated. In some implementations, mobile device 110 may utilize other mechanisms for determining the location of mobile device 110 as would be appreciated.

In some implementations, the mobile device 110 may receive a signal from the toll booth (or other tolling structure as would be appreciated) that either provides a position of the toll booth to the mobile device 110 or that facilitates the mobile device 110 in ascertaining the proximity to such toll booth. Such a signal may or may not specifically identify a position of the toll booth but nonetheless may assist the mobile device in determining its location based on such proximity.

In some implementations, toll database server 130 may receive, from mobile device 110, a request for toll coordinate information. In some implementations, the request may include the current GPS location or coordinates of the mobile device 110. In some implementations, toll coordinate information may include toll road coordinates (i.e., location or coordinates of one or more toll roads), toll plaza coordinates (i.e., location, place or coordinates of one or more toll plazas along each toll road), and/or the RF transmit and receive frequency associated with the toll plaza coordinates (i.e., the RF frequencies at which the toll booth radio device 150 and toll tag device 115 may communicate with one another, for example). In some implementations, toll database server 130 may store toll coordinate information in memory 135.

In some implementations, toll database server 130 may retrieve a portion of the toll coordinate information based on the current GPS location of the mobile device 110. In some implementations, toll database server 130 may compare the coordinates of the mobile device 110 with the toll plaza coordinates to determine one or more toll plazas that are located within a predetermined distance of the mobile device 110 as would be appreciated. In some implementations, toll database server 130 may retrieve a portion of the toll coordinate information based on the comparison. In other words, the retrieved portion of toll coordinate information may include toll plaza coordinates of the toll plaza(s) located within a particular distance of the mobile device 110, toll road coordinates of the toll road(s) on which the toll plaza(s) are located, and/or the RF transmit/receive frequencies and/or communication protocols associated with the toll plaza(s). In some implementations, toll database server 130 may communicate the retrieved potion of the toll coordinate information to the mobile device 110. In some implementations, the mobile device 110 may identify the RF transmit and receive frequencies and/or communication protocols associated with the toll plazas based on the received toll coordinate information. In some implementations, mobile device 110 may communicate the RF frequency information to the toll tag device 115, such that the toll tag device may tune in to the appropriate RF frequency for transmission and/or reception of RF signals to and/or from the toll booth radio device 150.

In some implementations, toll tag device 115 may include an embedded RFID (radio frequency identification) chip that transmits and receives radio signals. In some implementations, toll tag device 115 may include a transceiver circuit and an RF signal to audio signal converting circuitry (referred to hereinafter as “converter”). In some implementations, the transceiver circuit may tune in to an RF receive frequency of a toll booth radio device 150 (or toll plaza associated with the toll booth radio device). The RF receive frequency may be determined based on the toll booth payment system within which the toll booth radio device 150 operates, and the toll booth payment system may be determined based on the GPS location of the mobile device 110. In some implementations, the transceiver circuit may listen for an RF signal from the toll booth radio device 150 based on the toll booth payment system determined based on the GPS location of the mobile device. In some implementations, the transceiver circuit may receive a first RF signal from the toll booth radio device 150. In some implementations, the first RF signal may include a toll booth identifier identifying a toll booth plaza where the toll booth radio device 150 is provided and a location (i.e., place) of the toll booth plaza.

In some implementations, the transceiver circuit may communicate the first RF signal to the converter. In some implementations, the converter may convert the RF signal to a first audio signal. In some implementations, the converter may demodulate the RF (analog) signal and convert the RF signal to a digital signal. The converter may decode the digital signal. In some implementations, the converter may map the digital signal to a first audio signal comprising audio tones. In some implementations, the converter may communicate the first audio signal to mobile device 110. In some implementations, the converter may transmit the audio tones on the microphone pin of the 4 pin audio jack.

In some implementations, the mobile device/mobile application receives the first audio signal (audio tones) from the toll tag device 115. In some implementations, the mobile application may process the first audio signal and may determine the toll booth identifier and toll booth location from the first audio signal. In some implementations, the mobile application may cause the mobile device processor to store the toll booth identifier and location into mobile device memory (not otherwise illustrated in FIG. 1). In some implementations, the mobile application may cause the mobile device processor to communicate the toll booth identifier and location to toll database server 130.

In some implementations, the mobile application may generate a second audio signal. In some implementations, the mobile application may generate the second audio signal in response to the receipt of the first audio signal. In some implementations, the mobile application may retrieve user information from the mobile device memory. In some implementations, the user information may include user identification information associated with the user of the mobile device, user vehicle information, mobile device information, and/or other user information. In some implementations, the mobile application may convert the user information to a second audio signal comprising audio tones. In some implementations, the mobile application may communicate the second audio signal to toll tag device 115 for transmission. In some implementations, the mobile application may transmit the audio tones on either left or right receiver pins on the 4 pin audio jack.

In some implementations, toll tag device 115 may receive the second audio signal from the mobile device/mobile application. In some implementations, the toll tag device 115 may tune in to an RF transmit frequency of a toll booth radio device 150 (or toll plaza associated with the toll booth radio device). As described above, the appropriate RF transmit frequency may be determined based on a GPS location of the mobile device 110 and the corresponding toll booth payment system. In some implementations, the converter may convert the second audio signal (i.e., audio tones) to a digital signal, may encode and convert the digital signal to an analog second RF signal. In some implementations, the transceiver circuit may modulate and transmit, to the toll booth radio device 150, the second RF signal using an embedded antenna in the toll tag device 115 (i.e., transceiver circuit of the toll tag device).

In some implementations, toll booth radio device 150 may receive the second RF signal and may communicate the second RF signal to a toll authority database server (not otherwise illustrated in FIG. 1). Toll authority database server may process the RF signal to retrieve the user information.

In some implementations, toll database server 130 may determine a toll charge/toll fee for a vehicle. In some implementations, toll database server 130 may receive the start toll coordinates and the end toll coordinates from the mobile device 110. In some implementations, the start toll coordinates include the coordinates of a first toll plaza that the user passes (entry toll plaza at which the user enters, for example) and the end coordinates include the coordinates of a second toll plaza that the user passes (exit toll plaza at which the user exits, for example). In some implementations, toll database server 130 may determine a toll charge for a vehicle based on the start and end toll coordinates.

In some implementations, toll database server 130 may communicate the determined toll charge to the mobile device 110. The mobile device 110 may communicate with payment server 160 for the purposes of processing the payment of the toll charge.

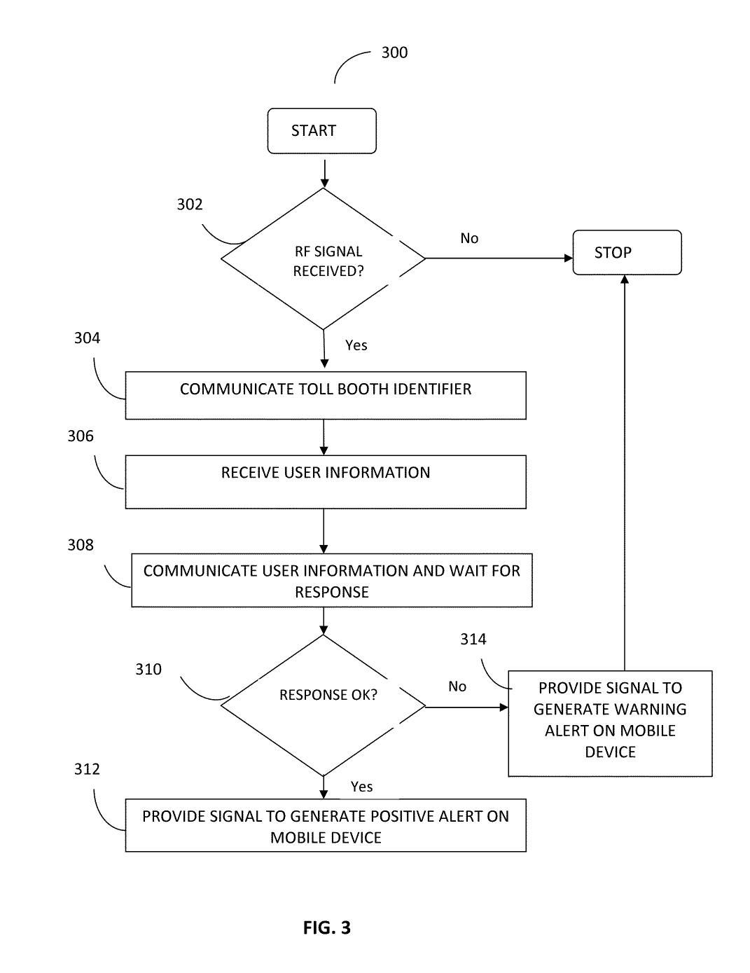

FIG. 3 is a flow diagram illustrating an example high-level operation of a toll tag device, according to various aspects of the invention. The various processing operations and/or data flows depicted in FIG. 3 (and in the other drawing figures) are described in greater detail herein. The described operations for a flow diagram may be accomplished using some or all of the system components described in detail above and, in some implementations of the invention, various operations may be performed in different sequences. According to various implementations of the invention, additional operations may be performed along with some or all of the operations shown in the depicted flow diagrams. In yet other implementations, one or more operations may be performed simultaneously. Accordingly, the operations as illustrated (and described in greater detail below) are examples by nature and, as such, should not be viewed as limiting.

In some implementations, toll tag device 115 may determine whether a first RF signal has been received from a toll booth radio device 150, in an operation 302. Based on a GPS location of mobile device 110 and the corresponding toll booth payment system associated with that location, mobile device 110 may configure toll tag device 115 to communicate with toll booth radio device 110. In some implementations, the RF signal may include toll booth identifier and/or location information. In response to a determination that an RF signal has been received, toll tag device 115 may communicate the toll booth identifier and/or location information to a mobile device 110, in an operation 304.

In some implementations, mobile device 110 may retrieve the user information from mobile device memory in response to the receipt of information from toll tag device 115. The mobile device 110 may communicate the user information to toll tag device 115. In some implementations, toll tag device 115 may receive the user information from mobile device 110, in an operation 306. In some implementations, toll tag device 115 may communicate the user information to toll booth radio device 150, in an operation 308. In some implementations, toll tag device may wait for a response back from the toll booth radio device, in an operation 308.

In some implementations, toll tag device 115 may receive a response from the toll booth radio device 150 and determine whether the response is ok (i.e., transmission/reception was successful), in an operation 310. In response to a determination that the response is ok, toll tag device 115 may provide a signal to mobile device 110 to generate a positive alert on the mobile device, in an operation 312. In response to a determination that the response is not ok, toll tag device 115 may provide a signal to mobile device 110 to generate a warning alert on the mobile device, in an operation 314.

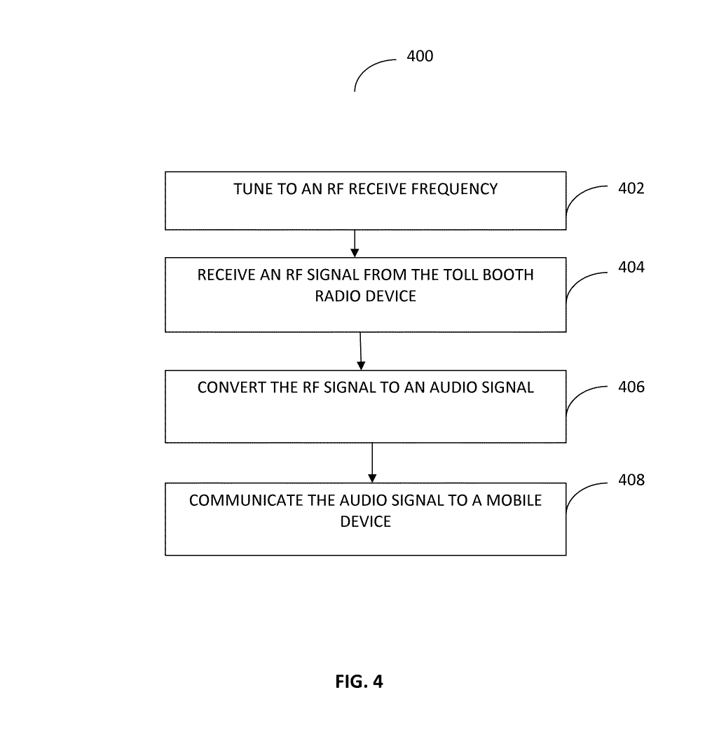

FIG. 4 is a flow diagram illustrating an example of a reception process 400 of the toll tag device, according to various implementations of the invention. In some implementations, process 400 may tune to an RF receive frequency based on the appropriate toll booth payment system as determined based on the GPS location of the mobile device, in an operation 402. In some implementations, process 400 may receive an RF signal from a toll booth radio device 150, in an operation 404. In some implementations, the RF signal may include toll booth identifier and/or location information associated with a toll booth radio device (i.e., toll plaza where the toll booth radio device is located). In some implementations, process 400 may convert the RF signal to an audio signal for mobile device consumption, in an operation 406. In some implementations, process 400 may communicate the audio signal to mobile device 110, in an operation 408.

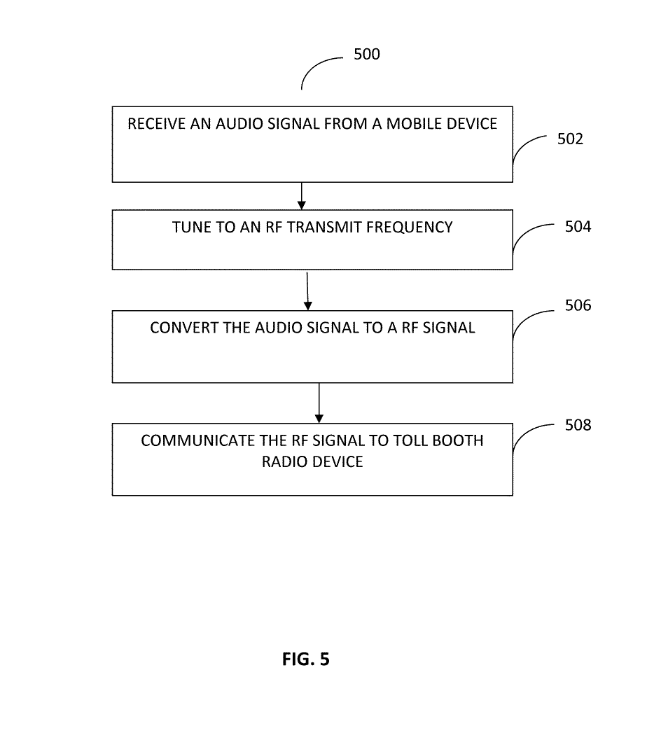

FIG. 5 is a flow diagram illustrating an example of a transmission process 500 of the toll tag device, according to various implementations of the invention. In some implementations, process 500 may receive an audio signal from a mobile device 110, in an operation 502. In some implementations, the audio signal may include user information retrieved from mobile device memory. In some implementations, process 500 may tune in to an RF transmit frequency based on the appropriate toll booth payment system as determined based on the GPS location of the mobile device, in an operation 504. In some implementations, process 500 may convert the audio signal to an RF signal for transmission, in an operation 506. In some implementations, process 500 may communicate the RF signal to a toll booth radio device 150, in an operation 508. In other words, process 500 may transmit the user information to the toll plaza identified by the toll booth identifier.

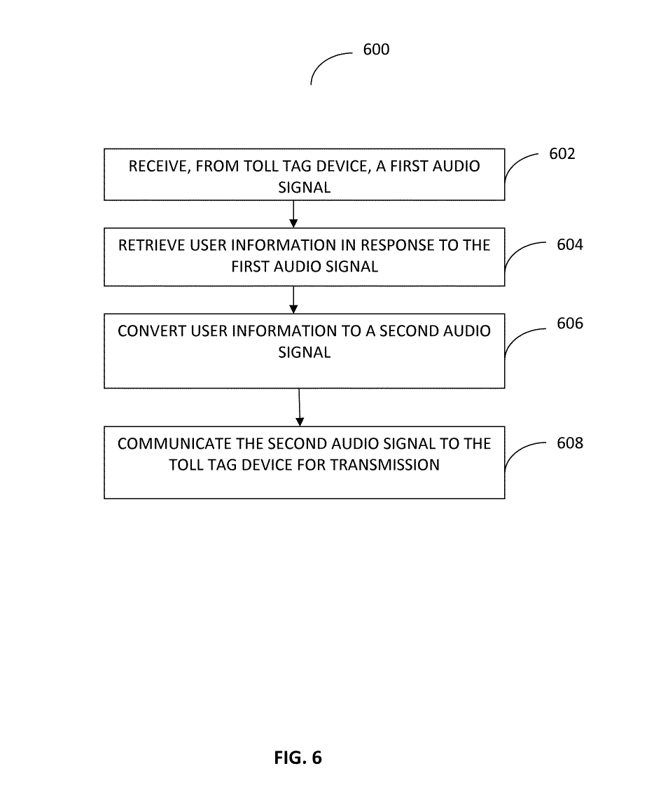

FIG. 6 is a flow diagram illustrating an example of a process 600 of the mobile device, according to various implementations of the invention. In some implementations, process 600 may receive a first audio signal from toll tag device 115, in an operation 602. In some implementations, the first audio signal may include toll booth identifier and/or location information received from a toll booth radio device 150.

In some implementations, process 600 may retrieve user information in response to receipt of the first audio signal, in an operation 604. In some implementations, process 600 may convert the user information to a second audio signal, in an operation 606. In some implementations, process 600 may communicate the second audio signal to the toll tag device 115 for transmission to the toll plaza identified by the toll booth identifier, in an operation 608.

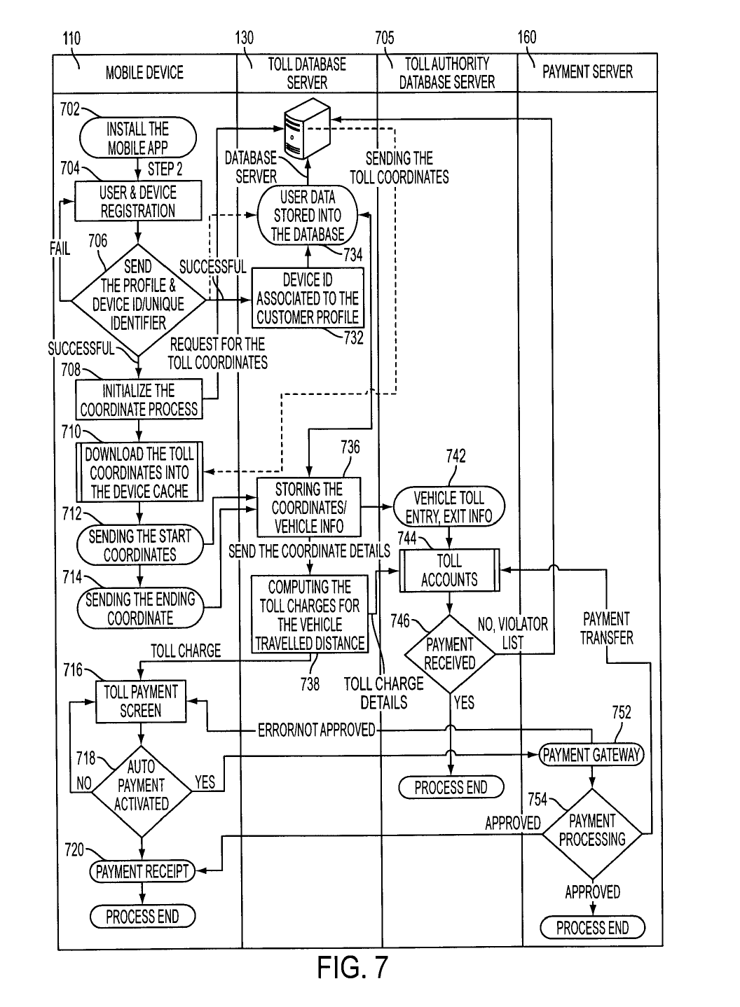

According to various implementations of the invention, FIG. 7 is diagram illustrating an example flow of data among various entities involved in the processing of toll-based payment transactions.

In some implementations, in an operation 702, a mobile application (such as a mobile toll payment application) may be downloaded and installed on mobile device 110. In an operation 704, the mobile application may be utilized by the user to register with the toll database server 130. During registration, the mobile application may prompt the user to enter user information. User information may include user identification information, user vehicle(s) information (for example, license plate number, state where the vehicle is registered, make, model, color, type/number of axle(s), etc.), mobile device information (for example, unique device ID), and/or other user information into a user interface associated with the mobile application. According to various implementations of the invention, the user identification information may include, among other things, payment card information such as a credit card number, debit card number, or other identifier that identifies a payment account used for the toll-based payment transaction. The payment account may be associated with the payment device (for example, payment card). In some implementations, the user identification information may further include a name of the cardholder (such as a name of the user), email address, mailing address, billing addresses, birth date, and/or other information related to the user and/or toll-based payment transaction.

In some implementations, the mobile application may detect whether the mobile device is registered with the toll database server 130. In response to a determination that the mobile device is not registered, the mobile application may prompt the user to register with the toll database server 130. In some implementations, the mobile application may communicate the user profile (including the user information) and device ID (which is a unique identifier identifying the mobile device 110) to toll database server 130.

In some implementations, the mobile application may determine whether the communication of the user profile and device ID was successful, in an operation 706. Toll database server 130 may associate the device ID with the user profile, in an operation 732 and/or may store the user information into a database 140 associated with the toll database server 130, in an operation 734. In some implementations, in response to a determination that the communication was unsuccessful, the process may return to operation 704.

In some implementations, the mobile application may initiate the coordinate initialization process, in operation 708. In some implementations, mobile application may detect the current GPS location or coordinates of the mobile device 110. The mobile application may send a request for toll coordinate information to toll database server 130. In some implementations, the request may include the current GPS location or coordinates of the mobile device 110.

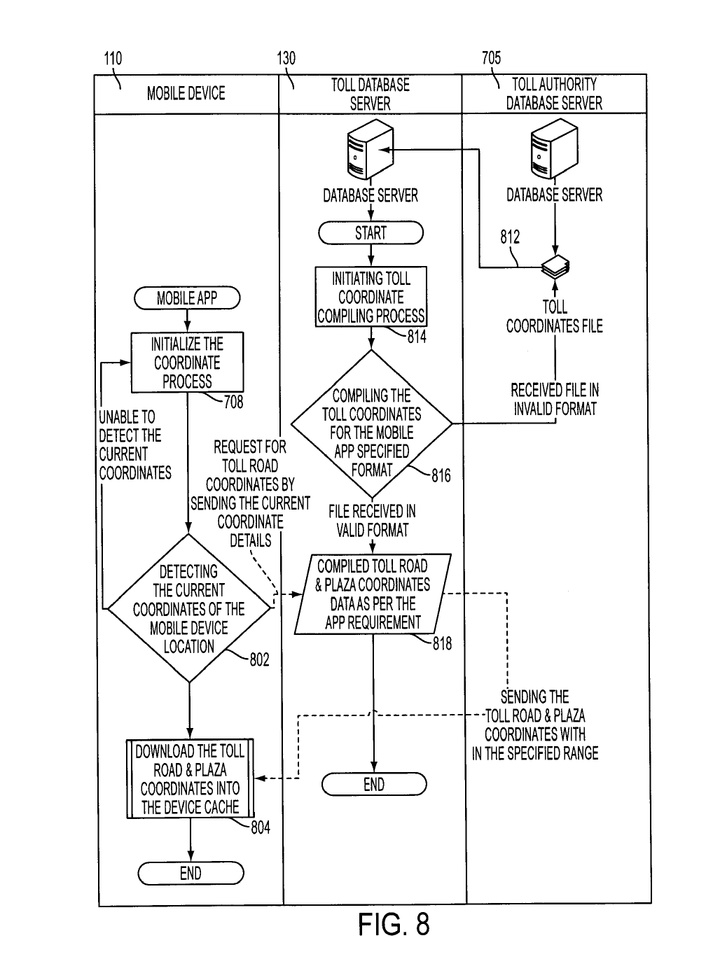

In some implementations, toll database server 130 may communicate the requested toll coordinate information to the mobile application. The mobile application may receive or download the requested toll coordinate information, in an operation 710. For example, FIG. 8 illustrates an example flow of data among various entities for communicating toll coordinate information, according to various implementations of the invention. In an operation 802, mobile application may detect the current GPS location or coordinates of the mobile device 110. The mobile application may send a request for toll coordinate information to toll database server 130. In some implementations, the request may include the current GPS location or coordinates of the mobile device 110. In some implementations, if the mobile application is unable to detect the current coordinates, the process may return to operation 708.

In some implementations, in an operation 812, toll database server 130 may receive a toll coordinates file from a toll authority database server 705. In some implementations, the toll coordinates file may include toll coordinate information, such as, toll road coordinates (i.e., location or coordinates of one or more toll roads), toll booth identifier, toll plaza coordinates (i.e., location, place and/or coordinates of one or more toll plazas along each toll road), and/or the RF transmit and receive frequency associated with the toll plaza coordinates (i.e., the RF frequencies at which the toll booth radio device 150 and toll tag device 115 may communicate with one another, for example).

Toll database server 130 may initiate a toll coordinate compiling process, in an operation 814. In an operation 816, toll database server may compile the toll coordinates file for the mobile application specified format. If the received file is in an invalid format, the process returns to operation 812. If the received file is in a valid format, the process proceeds to operation 818.

In some implementations, toll database server 130 may retrieve a portion of the toll coordinate information based on the current GPS location of the mobile device 110, in an operation 818. In some implementations, toll database server 130 may compare the coordinates of the mobile device 110 with the toll plaza coordinates to determine one or more toll plazas that are located within a particular distance (or a specified range) of the mobile device 110. In some implementations, toll database server 130 may retrieve a portion of the toll coordinate information based on the comparison. In other words, the retrieved portion of toll coordinate information may include toll plaza coordinates of the toll plaza(s) located within a particular distance of the mobile device 110, toll road coordinates of the toll road(s) on which the toll plaza(s) are located, and/or the RF transmit/receive frequencies associated with the toll plaza(s).

In some implementations, toll database server 130 may communicate the retrieved portion of the toll coordinate information to the mobile device 110, in an operation 818. The mobile application may receive (or download) the retrieved portion of the toll coordinate information in mobile device memory or cache, in an operation 804.

Referring back to FIG. 7, mobile device/mobile application may communicate the start toll coordinates to toll database server 130, in an operation 712. In some implementations, the start toll coordinates may include the coordinates of a first toll plaza that the user passes (entry toll plaza at which the user enters, for example). In some implementations, when the user passes through the first toll plaza, the toll booth radio device 150 associated with the first toll plaza may communicate the first toll booth identifier and first location to the toll tag device 115. The toll tag device 115 may communicate the first toll booth identifier and first location to the mobile device/mobile application. The mobile application may determine the first toll plaza coordinates based on the first toll booth identifier and/or first location. In some implementations, the mobile application may search the retrieved portion of toll coordinate information, based on the first toll booth identifier and/or first location to determine the first toll plaza coordinates. The mobile device/mobile application may communicate the determined first toll plaza coordinates to the toll database server 130, in an operation 712.

In some implementations, mobile device/mobile application may communicate the end toll coordinates to toll database server 130, in an operation 714. In some implementations, the end toll coordinates may include the coordinates of a second toll plaza that the user passes (exit toll plaza at which the user exits, for example). In some implementations, when the user passes through the second toll plaza, the toll booth radio device 150 associated with the second toll plaza may communicate the second toll booth identifier and second location to the toll tag device 115. The toll tag device 115 may communicate the second toll booth identifier and second location to the mobile device/mobile application. The mobile application may determine the second toll plaza coordinates based on the second toll booth identifier and/or second location. In some implementations, the mobile application may search the retrieved portion of toll coordinate information, based on the second toll booth identifier and/or second location to determine the second toll plaza coordinates. The mobile device/mobile application may communicate the determined second toll plaza coordinates to the toll database server 130, in an operation 714.

In some implementations, in an operation 736, toll database server 130 may store the start toll coordinates and the end toll coordinates, in memory 135, for example. In some implementations, toll database server 130 may determine a toll charge (i.e., amount of toll to be paid) for a vehicle based on the start toll coordinates and end toll coordinates, in an operation 738. In some implementations, the toll database server 130 may communicate the start toll coordinates and the end toll coordinates to toll authority database server 705.

In some implementations, toll database server 130 may communicate the determined toll charge to the mobile device 110 and/or toll authority database server 705, in an operation 738. In some implementations, mobile application may display the toll charge and prompt the user for payment on a toll payment screen (user interface), in an operation 716. In some implementations, mobile application may determine whether an auto-payment feature is activated, in an operation 718. In some implementations, in response to a determination that the auto-payment feature is activated, the mobile application may communicate pre-stored payment information (for example, payment card information etc.) with payment server 160 for processing payment of the toll charge. In some implementations, in response to a determination that the auto-payment feature is not activated, the mobile application may prompt the user to manually enter payment information regarding form of payment (for example, payment card information etc.) to be used for processing the toll-based payment transaction (including payment of toll charge), in operation 716). The mobile application may communicate the manually entered payment information to payment server 160 for processing the payment of toll charge. In some implementations, the payment information may include information associated with a payment device (such as, a payment card) to be used for payment of toll charge. For example, the payment information may include type of payment device (such as, credit card, debit card, or a pre-paid payment card), name of user or card holder, payment card number, expiration date, card verification number, billing address, and/or other information.

In some implementations, the payment server 160 may receive the payment information (pre-stored or manually entered) from the mobile application, in an operation 752. In an operation 754, payment server 160 may process the toll-based payment transaction (involving payment of the toll charge). According to various implementations of the invention, payment server 160 may be communicably coupled to a variety of financial networks, financial institutions, and/or other entities that authorize and settle toll-based payment transactions (using payment cards, for example). In this manner, payment server 160 may provide processing of toll-based payment transactions using a robust array of payment devices and the respective financial institutions that issue, authorize, approve, and settle payments originating from use of the payment devices.

In some implementations, payment server 160 may determine whether the toll-based payment transaction is approved based on the received payment information. In some implementations, payment server 160 may determine a payment account associated with the toll-based payment information. In some implementations, the payment account may include a bank account, debit account, and/or other account associated with the account holder (i.e., user). According to various implementations of the invention, payment server 160 may query a database 168 to identify the payment account based on the received payment information.

In some implementations, database 168, may include information related to a payment account, such as, for example, credit card numbers, debit card numbers, account holder contact information, account holder information, an identity of mobile device 110 used by the account holder (for example device identifier), and/or other information. According to various implementations of the invention, examples of database 168, include, for instance, a relational database, a filesystem, and/or other device or data representation configured for data storage.

In some implementations, payment server 160 may determine whether the payment account has sufficient funds to cover the toll charge. In some implementations, in response to a determination that the payment account has sufficient funds, the payment server 160 may initiate debit of a payment amount (i.e., amount for payment of toll charge) from the payment account. The payment amount may be transferred to a toll authority account associated with the toll authority database server 705.

In some implementations, payment server 160 may determine that the toll-based payment transaction is approved upon successful payment amount debit and/or transfer. In some implementations, payment server 160 may generate a transaction identifier (unique identifier identifying the transaction) for the toll-based payment transaction. In some implementations, payment server 160 may generate a payment receipt and communicate the payment receipt to mobile device/mobile application, in an operation 720. In some implementations, the payment receipt may indicate that the toll-based payment transaction is approved, the transaction identifier and/or the payment amount for which the payment transaction is approved. In some implementations, the mobile application executed by mobile device 110 may cause the receipt page including the payment amount associated with the toll-based payment transaction to be displayed via an interface of the mobile device 110.

In some implementations, payment server 160 may determine that the toll-based payment transaction is not approved and the process may return to operation 716, where the user may be prompted to re-enter the payment information.

In some implementations, toll authority database server 705 may receive the start toll coordinates and the end toll coordinates from the toll database server 130, in an operation 742. In some implementations, toll authority database server 705 may receive the determined toll charge from toll database server 130, in an operation 744. In some implementations, toll authority database server 705 may receive the payment transfer into a toll authority account from payment server 160, in an operation 744. In some implementations, toll authority database server 705 may determine whether a payment is received, in an operation 746. In response to a determination that payment has not been received, the user is identified as a violator. The user may be added to a list of violators compiled by the toll authority database server 704 and the may be communicated to toll database server 130.

In some implementations of the invention, mobile device 110, toll database server 130, payment server 160, or other computing device may store a history of toll-based payment transactions. The history may include, without limitation, a date, a time, license plate number of the vehicle, toll road information, toll plaza information, toll charge, last four digitals of a payment card used for payment of toll charge, a transaction identifier, and/or other information. In this manner, an account holder or other operators of these devices may have a log of transactions in the event that a particular transaction is questioned.

For example, in operation, a user with a mobile device 110 (and toll tag device 115) approaches a toll plaza. A mobile toll payment application may be already downloaded and installed on the mobile device 110 and the mobile device may be registered with the toll database server 130. In other words, the mobile application may be utilized by the user to register with the toll database server 130. Thus, the mobile application may be continuously running on the mobile device 110 while the user drives toward a toll plaza. The mobile application may identify the current GPS location of the mobile device. The mobile application may download, from the toll database server 130, the toll road coordinates and toll plaza coordinates associates with the toll roads and toll plazas within a particular distance from the mobile device.

When the toll tag device 115 and a first toll booth radio device 150 (of a first toll plaza) are within a pre-determined distance, the two devices communicate with one another to exchange information. The first toll booth radio device 150 may communicate the first toll booth identifier and location information to the toll tag device 115. The toll tag device 115 may communicate the first toll booth identifier and location information to the mobile application. The mobile application may determine the first toll road coordinates and first toll plaza coordinates based on the first toll booth identifier and location information, and may communicate the first toll road coordinates and first toll plaza coordinates to toll database server 130.

When the toll tag device 115 and a second toll booth radio device 150 (of a second toll plaza) are within a pre-determined distance, the two devices communicate with one another to exchange information. The second toll booth radio device 150 may communicate the second toll booth identifier and location information to the toll tag device 115. The toll tag device 115 may communicate the second toll booth identifier and location information to the mobile application. The mobile application may determine the second toll road coordinates and second toll plaza coordinates based on the second toll booth identifier and/or location information, and may communicate the second toll road coordinates and second toll plaza coordinates to toll database server 130.

Toll database server 130 may determine a toll charge based on the received first and second coordinates and may communicate the toll charge to the mobile application for payment. The mobile application may communicate with a payment server for processing the payment for toll charge.

In some implementations of the invention, when multiple users each with their own mobile device (including the mobile application) travel together, the mobile applications may be configured such that one mobile device takes “priority” over other mobile devices within close proximity of one another for purposes of payment. This may be accomplished, for example, by registering multiple mobile devices with a single user account and assigning priorities/rankings to each of the corresponding mobile devices. In some implementations, each of the mobile applications operating on the multiple mobile devices may detect others operating in close proximity for a predetermined length of time (e.g., several minutes) and provide user interfaces whereby the users of the mobile devices may select which of their mobile devices will be used to process payment of toll charges as would be appreciated.

In some implementations, mobile device 110 may include a processor (not otherwise illustrated in FIG. 1), circuitry, and/or other hardware operable to execute computer-readable instructions and/or mobile applications. In some implementations, mobile device 110 may execute a mobile application described herein In some implementations, mobile device 110 may include a memory (not otherwise illustrated in FIG. 1) that includes one or more tangible (i.e., non-transitory) computer readable media. The memory may include one or more instructions that when executed by the processor configures the processor to perform functions of mobile device 110/mobile application.

In some implementations, payment server 160 may include a processor 162, a memory 165, and/or other components that facilitate the functions of payment server 160. In some implementations, processor 162 includes one or more processors configured to perform various functions of payment server 160. In some implementations, memory 165 includes one or more tangible (i.e., non-transitory) computer readable media. Memory 165 may include one or more instructions that when executed by processor 162 configure processor 162 to perform functions of payment server 130. In some implementations, memory 165 may include one or more instructions stored on tangible computer readable media that when executed at a remote device, such as mobile device 110, cause the remote device to perform various functions of the remote device described herein and to facilitate interaction with payment server 160, as described herein.

In some implementations, toll database server 130 may include a processor 132, a memory 135, and/or other components that facilitate the functions of toll database server 130. In some implementations, processor 132 includes one or more processors configured to perform various functions of toll database server 130. In some implementations, memory 135 includes one or more tangible (i.e., non-transitory) computer readable media. Memory 135 may include one or more instructions that when executed by processor 132 configure processor 132 to perform functions of toll database server 130. In some implementations, memory 135 may include one or more instructions stored on tangible computer readable media that when executed at a remote device, such as mobile device 110, cause the remote device to perform various functions of the remote device described herein and to facilitate interaction with toll database server 130, as described herein.

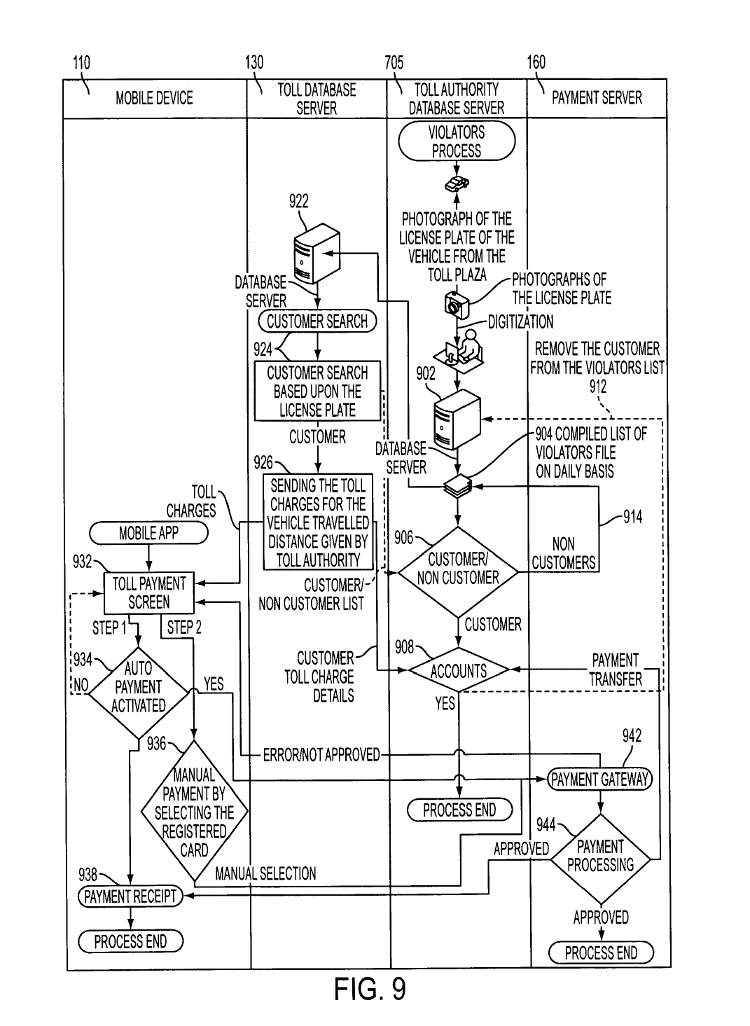

FIG. 9 is a diagram illustrating an example flow of data among various entities for determining violators, according to various implementations of the invention. In some implementations, video cameras may be installed on the toll plaza and are configured to capture pictures of license plates of the vehicles passing through the toll plaza. In some implementations, video cameras capture the pictures of the license plates of violators (i.e., users who pass through the toll plaza without a toll tag device 115). The captured pictures may be provided to toll authority database server 705. In some implementations, the captured pictures may be digitized and the digitized images may be provided to toll authority database server 705, in an operation 902. In some implementations, toll authority database server 705 may compile a list of violators, in an operation 904. In some implementations, toll authority database server 705 may generate a list of violators file on a daily basis. In some implementations, the list may include, for each violator, the digitized image of the license plate, the toll charges to be paid, and/or other information. In some implementations, toll authority database server 705 may communicate the list to toll database server 130, in an operation 922.

In some implementations, in an operation 924, toll database server 130 may query database 140 (that stores user information) based on each license plate number from the list to determine a user who owns the vehicle with the license plate. In other words, toll database server 130 may search through the user information to determine a user associated with each license plate. In some implementations, if the toll database server 130 finds a user associated with a license plate in database 140, the user may be identified as a customer, and otherwise as a non-customer. In some implementations, the toll database server 130 may communicate the customer/non-customer list to toll authority database server 705, in an operation 906. According to various implementations of the invention, examples of database 140, include, for instance, a relational database, a filesystem, and/or other device or data representation configured for data storage.

In some implementations, toll database server 130 may communicate the toll charges associated with the violator (who is identified as a customer) to the mobile application, in an operation 926. In some implementations, the mobile application may display the toll charges and prompt the user for payment on a toll payment screen (user interface), in an operation 932. In some implementations, mobile application may determine whether an auto-payment feature is activated, in an operation 934. In some implementations, in response to a determination that the auto-payment feature is activated, the mobile application may communicate pre-stored payment information (for example, payment card information etc.) with payment server 160 for processing payment of the toll charge. In some implementations, in response to a determination that the auto-payment feature is not activated, the mobile application may determine whether the user has opted for manual payment, in an operation 936. The user may manually select a previously registered payment card to be used for processing the toll-based payment transaction (including payment of toll charge), in operation 936. The mobile application may communicate the payment information associated with the registered payment card to payment server 160 for processing the payment of toll charge. In some implementations, the payment information (regardless of whether the auto-payment feature is activated or not) may include information associated with a payment device (such as, a payment card) to be used for payment of toll charge. For example, the payment information may include type of payment device (such as, credit card, debit card, or a pre-paid payment card), name of user or card holder, payment card number, expiration date, card verification number, billing address, and/or other information.

In some implementations, the payment server 160 may receive the payment information from the mobile application, in an operation 942. In an operation 944, payment server 160 may process the toll-based payment transaction (involving payment of the toll charge). According to various implementations of the invention, payment server 160 may be communicably coupled to a variety of financial networks, financial institutions, and/or other entities that authorize and settle toll-based payment transactions (using payment cards, for example). In this manner, payment server 160 may provide processing of toll-based payment transactions using a robust array of payment devices and the respective financial institutions that issue, authorize, approve, and settle payments originating from use of the payment devices.

In some implementations, payment server 160 may determine whether the toll-based payment transaction is approved based on the received payment information. In some implementations, payment server 160 may determine a payment account associated with the toll-based payment information. In some implementations, the payment account may include a bank account, debit account, and/or other account associated with the account holder (i.e., user). According to various implementations of the invention, payment server 160 may query a database 168 to identify the payment account based on the received payment information.

In some implementations, database 168, may include information related to a payment account, such as, for example, credit card numbers, debit card numbers, account holder contact information, account holder information, an identity of mobile device 110 used by the account holder (for example device identifier), and/or other information. According to various implementations of the invention, examples of database 168, include, for instance, a relational database, a filesystem, and/or other device or data representation configured for data storage.

In some implementations, payment server 160 may determine whether the payment account has sufficient funds to cover the toll charge. In some implementations, in response to a determination that the payment account has sufficient funds, the payment server 160 may initiate debit of a payment amount (i.e., amount for payment of toll charge) from the payment account. The payment amount may be transferred to a toll authority account associated with the toll authority database server 705.

In some implementations, payment server 160 may determine that the toll-based payment transaction is approved upon successful payment amount debit and/or transfer. In some implementations, payment server 160 may generate a payment receipt and communicate the payment receipt to mobile device/mobile application, in an operation 938. In some implementations, the payment receipt may indicate that the toll-based payment transaction is approved and the payment amount for which the payment transaction is approved. In some implementations, the mobile application executed by mobile device 110 may cause the receipt page including the payment amount associated with the toll-based payment transaction to be displayed via an interface of the mobile device 110.

In some implementations, payment server 160 may determine that the toll-based payment transaction is not approved and the process may return to operation 932, where the user may be prompted to re-enter the payment information.

In some implementations, the toll authority database server 705 may receive the customer/non-customer list from toll database server 130, in an operation 906. In some implementations, toll authority database server 705 may determine whether a user in the list of violators is a customer or non-customer based on the customer/non-customer list, in an operation 906. In some implementations, non-customers may not be removed from the violators list, in an operation 914.

In some implementations, toll authority database server 705 may receive the toll charge details associated with a customer from toll database server 130, in an operation 908. In some implementations, toll authority database server 705 may receive the payment transfer into a toll authority account from payment server 160, in an operation 908. In some implementations, toll authority database server 705 may determine whether account have been cleared (i.e., payment covering toll charges is received), in an operation 908. In response to a determination that account has been cleared, toll authority database server 705 may remove the customer from the violators list, in an operation 912. In some implementations, in response to a determination that account has not been cleared, the customer may not be removed from the violator list, and the user is identified as a violator. The user may be added to a list of violators compiled by the toll authority database server 704 and the may be communicated to toll database server 130.

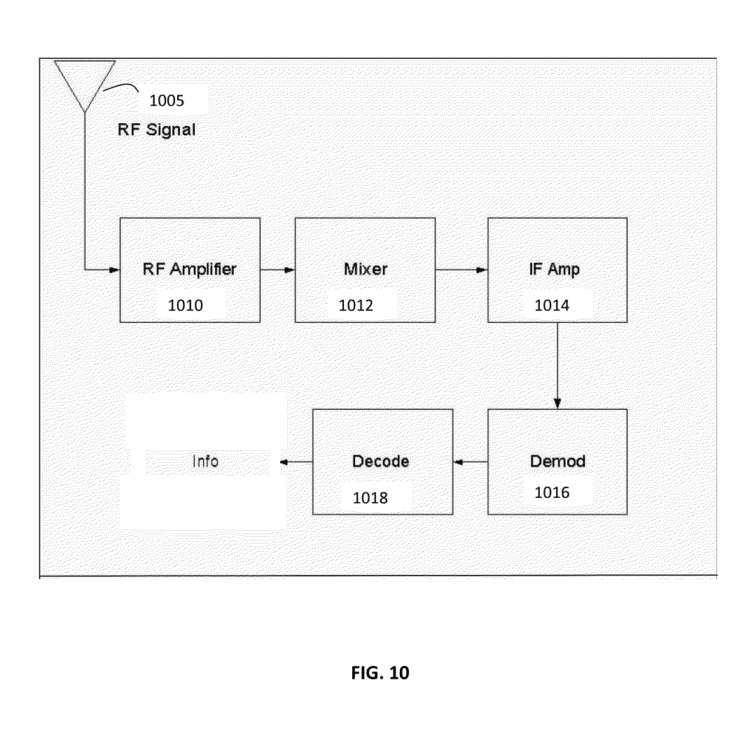

FIG. 10 is a block diagram illustrating example components of a wireless transceiver implemented or integrated in mobile device 110, according to various implementation of the invention. In some implementations, the wireless transceiver may be configured to generate and process the RF signals from/to the toll booth radio device 150. In these implementations, the mobile device 110 may itself act as a toll tag device without the need for an external toll tag device 115 attached to the mobile device 110. In this implementations, the wireless transceiver may perform the various functions of the toll tag device 115 described above.

In some implementations, the wireless transceiver components may be implemented in software in a mobile application, wherein the mobile application executed by the mobile device may use the software-based wireless transceiver components to generate and process the RF signals from/to the toll booth radio device 150.

As depicted in FIG. 10, antenna 1005 may receive an RF signal from toll booth radio device 150. The RF signal may include toll booth identifier and/or location information. The RF signal may be amplified by an RF amplifier 1010. The amplified signal is mixed with a local oscillator signal by mixer 1012 to create an intermediate frequency (IF). The IF may be amplified by IF amplifier 1014. The amplified IF may be demodulated by demodulator 1016. The demodulated signal may be decoded by decoder 1018 to retrieve the toll booth identifier and/or location information.

Similarly, user information may be encoded, modulated, amplified, and transmitted to toll booth radio device 150 via antenna 1005, as would be appreciated.

In some implementations, while the wireless transceiver is described herein as a device configured to communicate via radio communications (such as an RFID device), the wireless transceiver may communicate via various wireless technologies, including but not limited to, short range communication technologies (such as, NFC (near field communication), Bluetooth, etc.), microwave communication technologies, infrared communication technologies, and/or other wireless technologies, without departing from the scope of the invention.

In some implementations, the functionality of the toll tag device may be incorporated into a vehicle's electronics system (processor). In some implementations, the vehicle's electronics system may include a wireless transceiver that is configured to generate and process the RF signals from/to the toll booth radio device 150. In these implementations, the mobile device 110 may be coupled to the vehicle's electronic system. The mobile device 110 (or mobile application) may sync or communicate with the vehicle's electronic system (wirelessly via Bluetooth and/or via a USB connection, for example). The user may control the mobile application via voice commands or vehicle's components (such as steering wheel controls, radio controls, etc.), thereby allowing the user to pay tolls using the mobile device and/or the vehicle's system.

In some implementations, the functionality of the toll tag device and the mobile device (mobile application) may be incorporated into the vehicle's electronic system. A user may interact with the vehicle's electronic system via a user interface generated by the system (e.g., processor). In these implementations, a user may utilize the user interface to facilitate communication with toll database server 130 and payment server 160, to allow for payment of tolls.

In some implementations of the invention, the mobile application utilizes the GPS location of mobile device 110 without benefit of any radio communications between, for example, a toll tag device 115 or a toll booth radio device 150. In these implementations, no toll tag device 115 (or equivalent functionality embedded in mobile device) is utilized. Instead, the mobile application collects the GPS location of mobile device 110 and records when mobile device 110 passes within a predetermined distance of a toll plaza or other tolling location based on toll coordinate information retrieved from a toll database server 130. In some implementations, the mobile application records a time, a location, an identification of the tolling location, and/or other recorded information when mobile device 110 passes within the predetermined distance of the tolling location. These implementations may be useful, for example, in open road tolling systems that do not require interaction with toll booth radio device 150 in order to raise/lower a gate across a travel lane. In these implementations of the invention, the mobile application communicates with toll database server 130 or payment server 160 in order to process payment of tolls. In some implementations, the mobile application communicates, via mobile device 110, with payment server 160 or toll database server 130 as/after mobile device 110 passes with the predetermined distance of each tolling location to process the particular toll associated with that tolling location. In some implementations, the mobile application communicates, via the mobile device 110, with payment server 160 or toll database server 130 at a periodic rate (e.g., hourly, daily, weekly, monthly, etc.) to process the tolls accumulated over the corresponding period by the mobile device 110.

As discussed above, in some implementations, toll database server 130 may use the recorded information associated with the mobile device 110 passing through/proximate to tolling location(s) to reconcile users of mobile device 110 against a list of violators provided to toll database server 130 by toll authority database server 705. In these implementations, toll database server 130 may facilitate payment of tolls incurred by its customers (e.g., users of mobile device(s) 110) to toll authority database server 705.

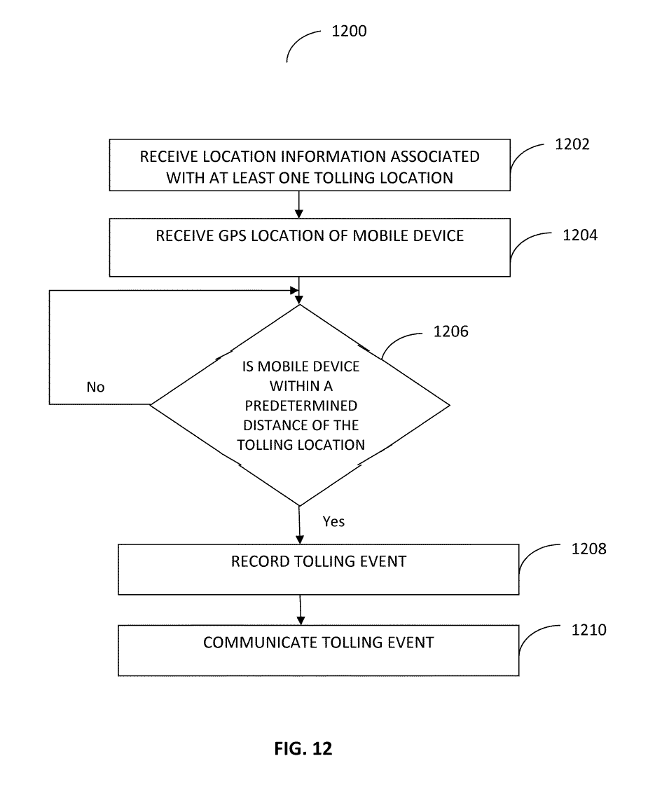

FIG. 12 illustrates a process for paying tolls according to various implementations of the invention. In an operation 1202, the mobile application receives information regarding a plurality of tolling locations from, for example, toll database server 130. In some implementations, the mobile application receives information regarding a plurality of tolling locations within a predetermined distance of mobile device 110 (e.g., one mile, ten miles, fifty miles or other such predetermined distance as would be appreciated). In some implementations, the mobile application receives all known tolling locations within a particular region, state, country, etc. In some implementations, the mobile application receives information regarding one or more tolling locations within a predetermined distance and/or along a predicted path of mobile device as travels as would be appreciated.

In an operation 1204, the mobile application receives a GPS location of mobile device 110. In an operation 1206, the mobile application compares the GPS location with the information associated with each of the plurality of tolling locations to determine whether the mobile device 110 is within a predetermined distance of the tolling location for purposes of assessing a toll to an account associated with the mobile device 110. If the mobile device 110 is within the predetermined distance of the tolling location, the mobile application, in an operation 1208, records a tolling event and in an operation 1210, communicates the tolling event to toll database server 160. As discussed above, operation 1210 may be performed as/after mobile device passes through each tolling location or periodically (e.g., hourly, daily, monthly) to report a number of passes of mobile device 110 through one or more tolling locations. If the mobile device 110 is not within the predetermined distance of the tolling location, the mobile application returns to operation 1206.

In some implementations of the invention, mobile application performs operation 1206 periodically (e.g., every second, every five seconds, every ten seconds, every thirty seconds, or other interval as would be appreciated). In some implementations of the invention, mobile application performs operation 1206 based on an incremental distance traveled by mobile device 110 (e.g., every ten feet travelled, every fifty feet travelled, every hundred feet travelled or other incremental distance as would be appreciated). In some implementations of the invention, mobile application performs operation 1206 based on a speed of travel of mobile device 110 as would be appreciated. In some implementations of the invention, mobile device performs operation 1206 based on a trajectory of mobile device 110 and whether such trajectory includes passing through one or more tolling locations. Other periods/distances for performing operation 1206 may be utilized given loading and/or processing capabilities of mobile device 110 as would be appreciated.

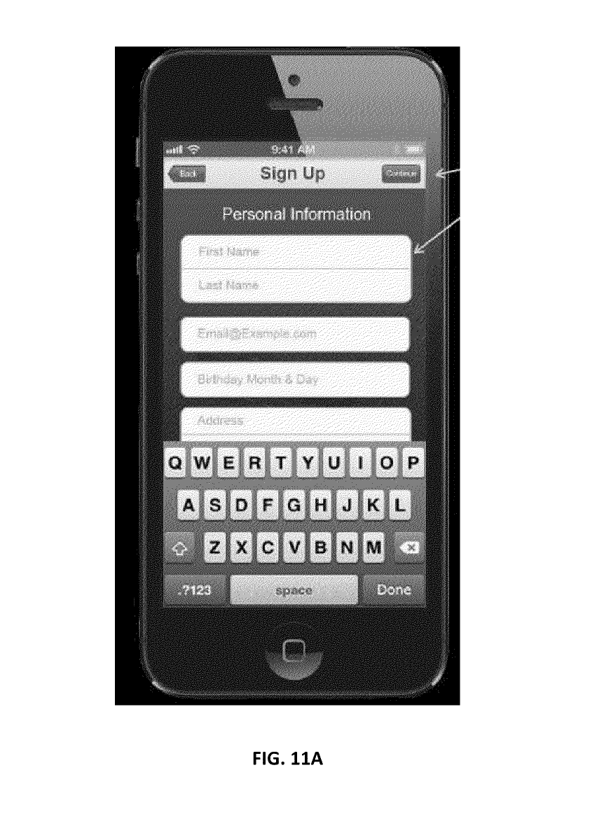

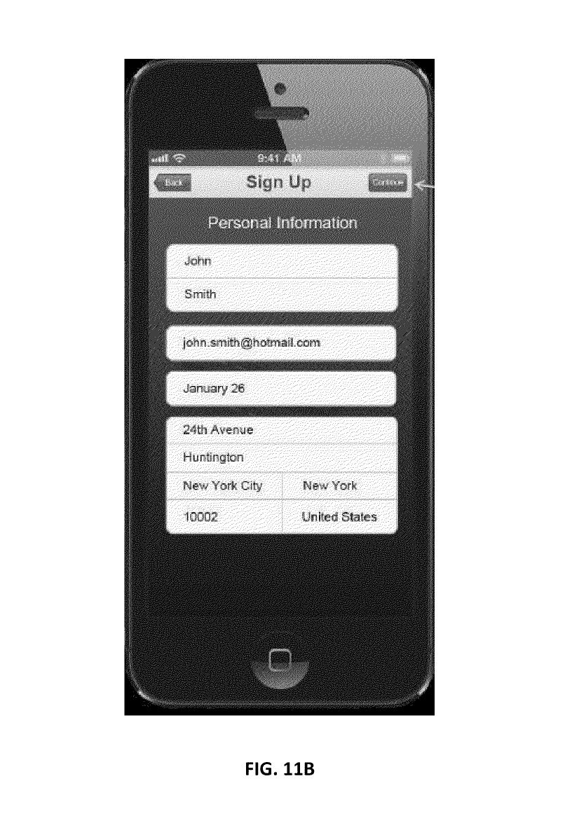

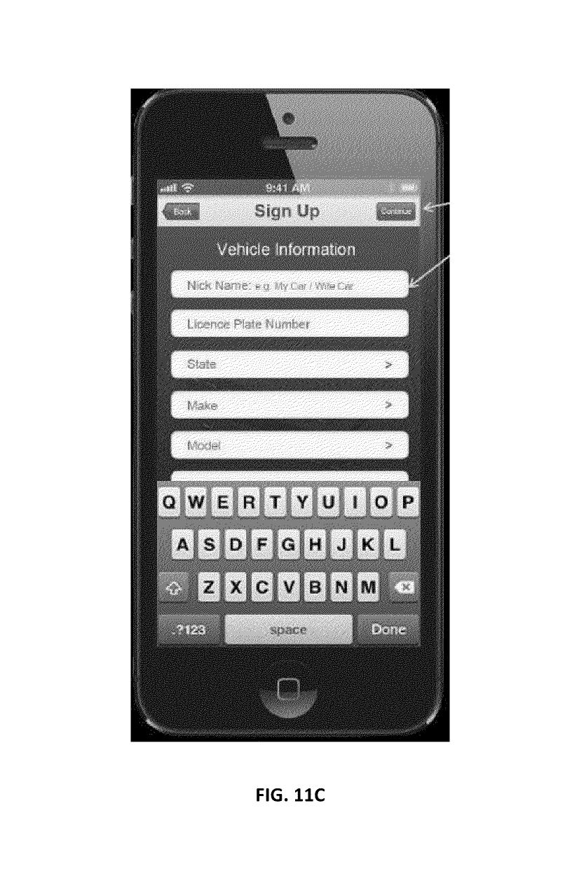

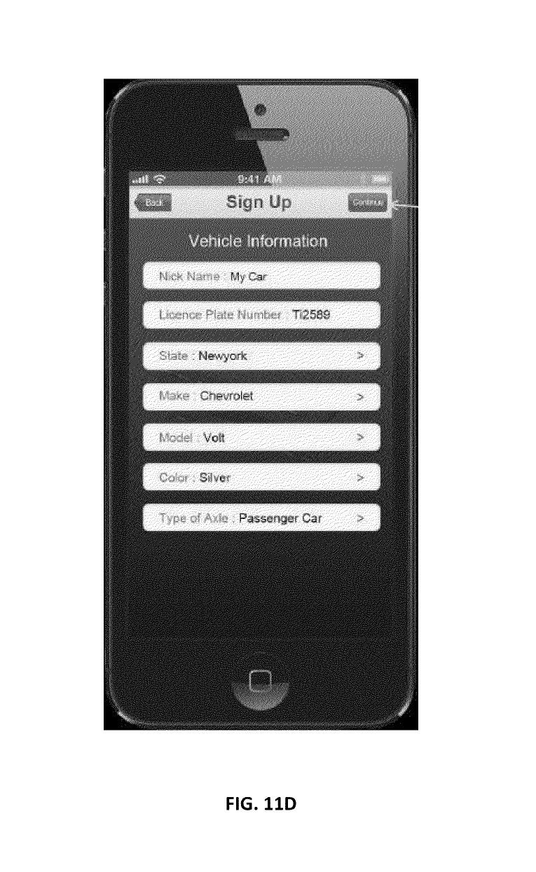

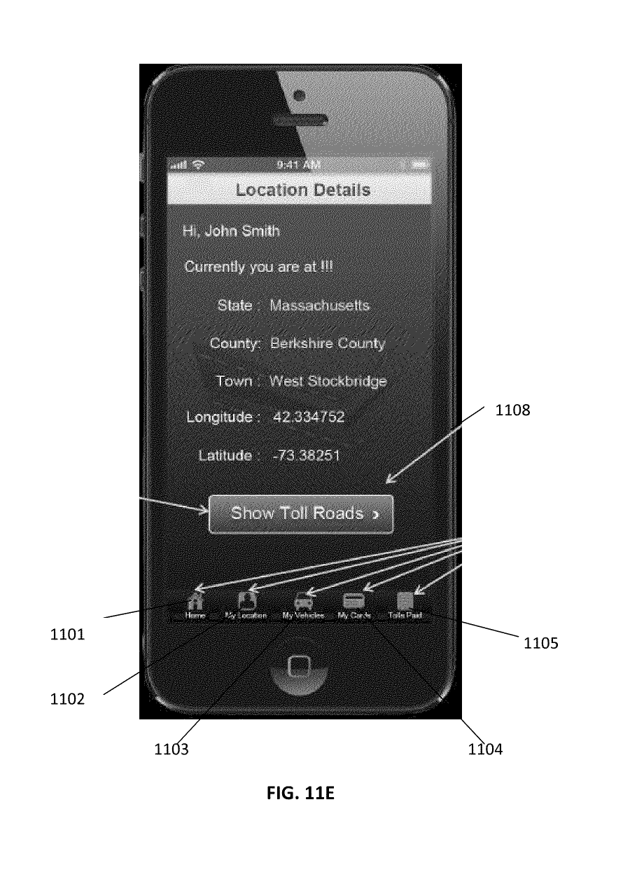

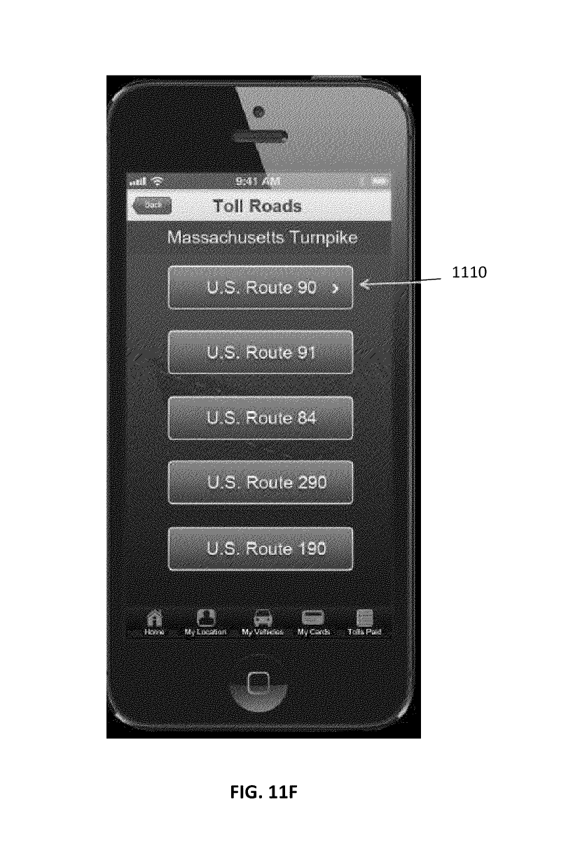

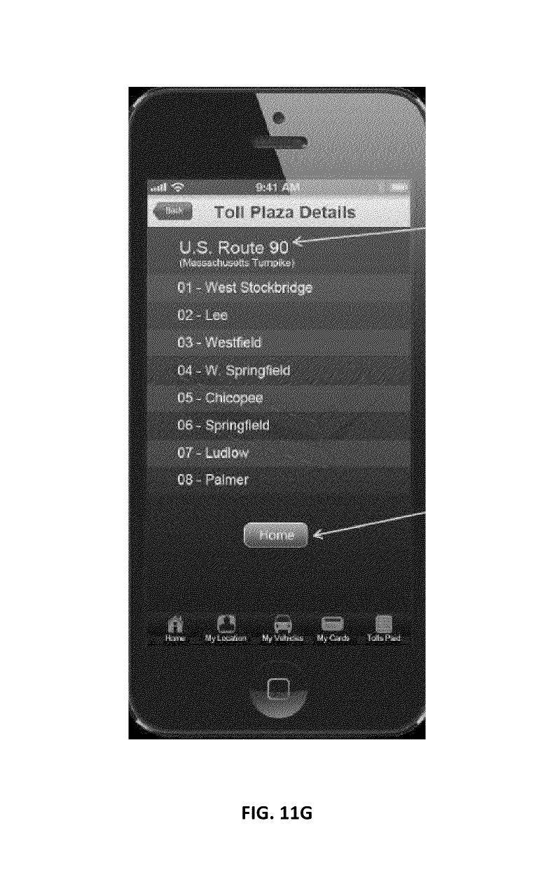

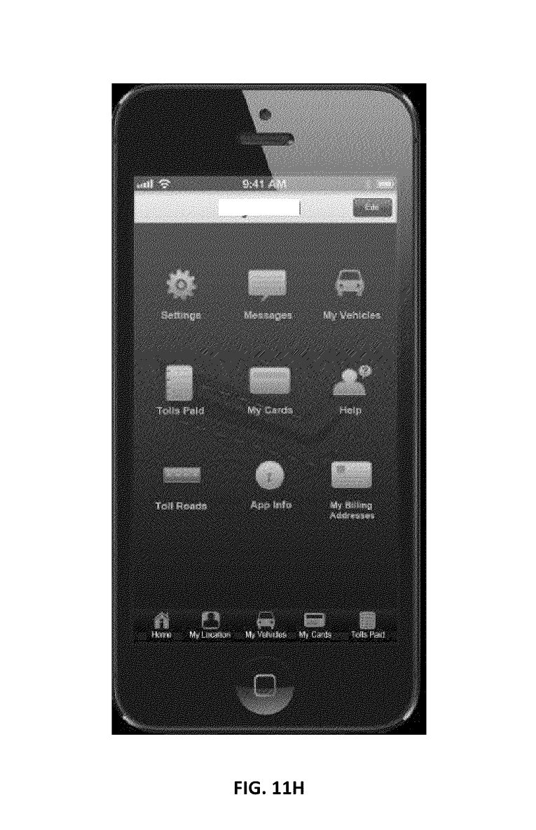

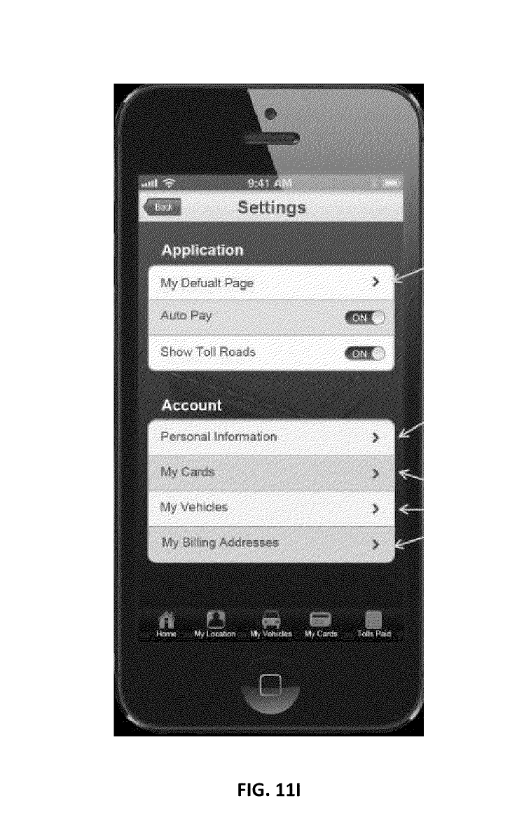

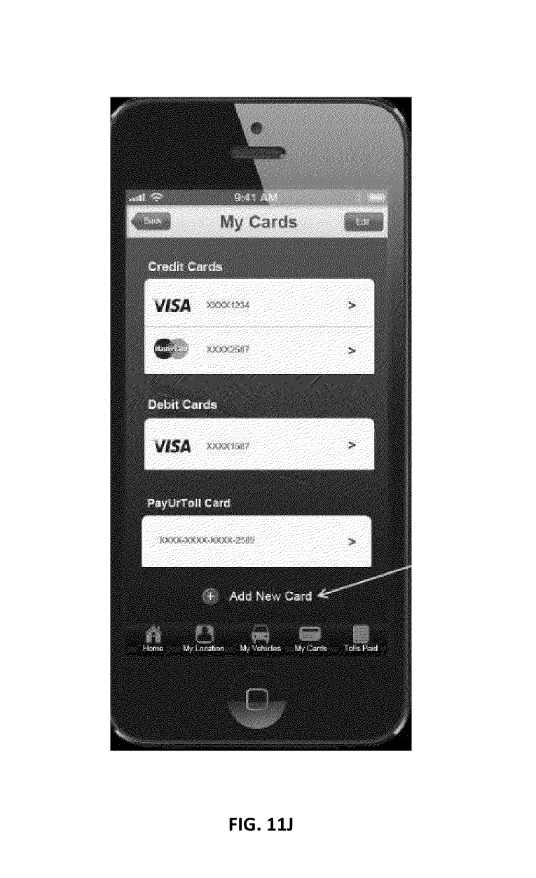

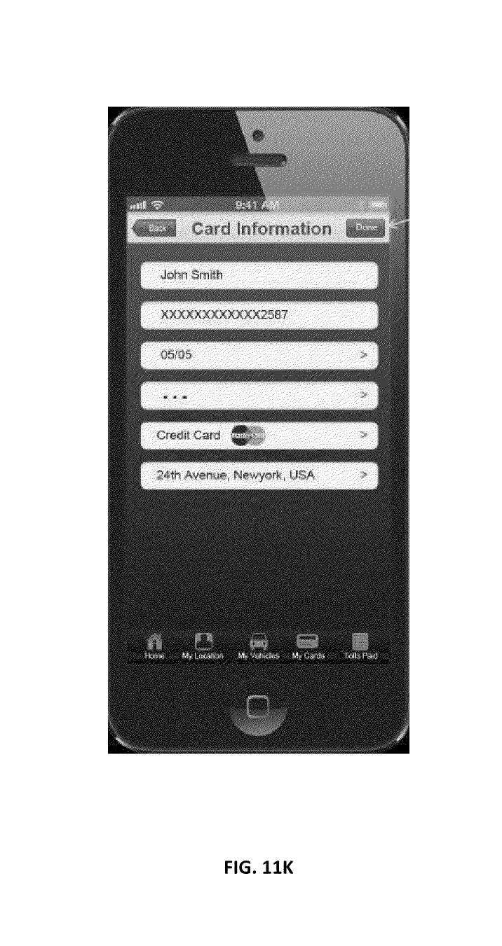

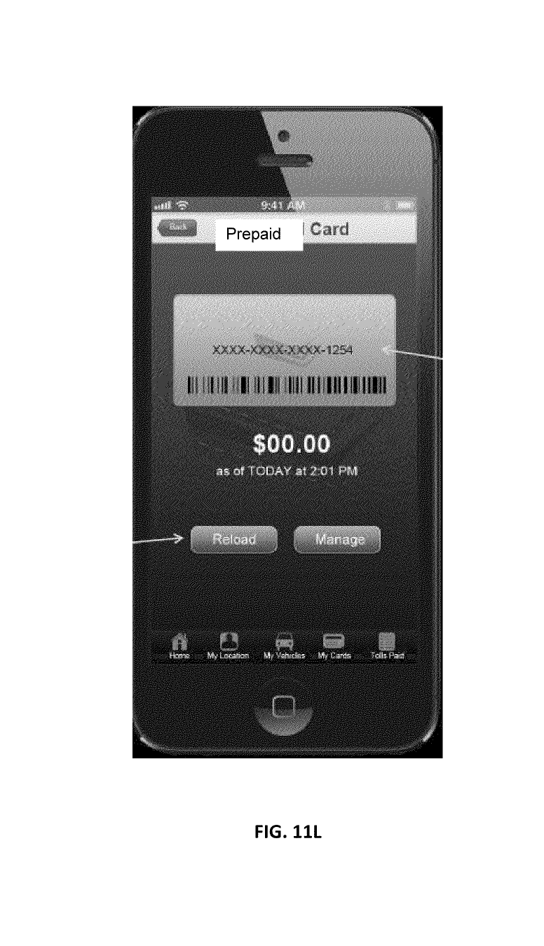

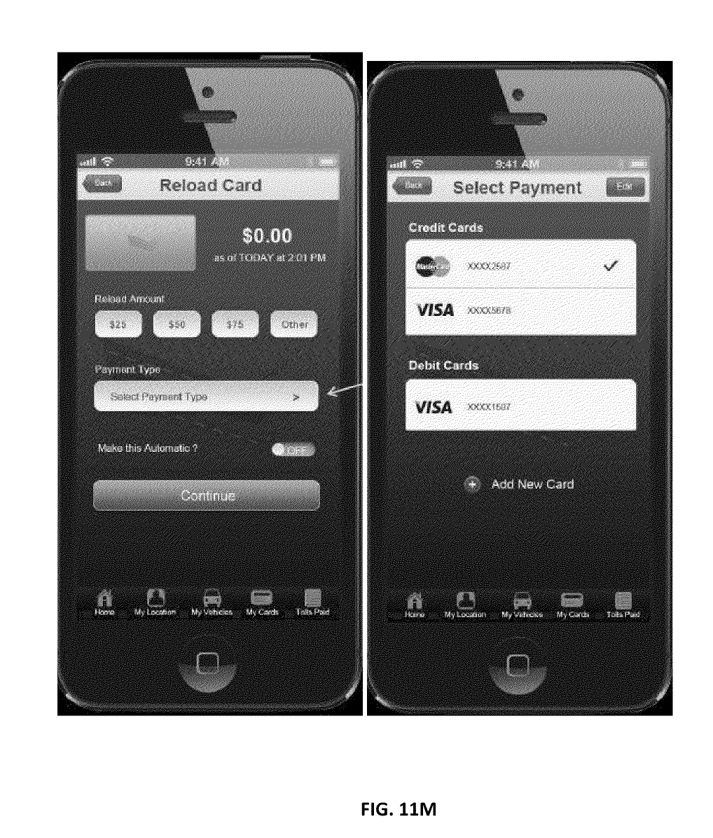

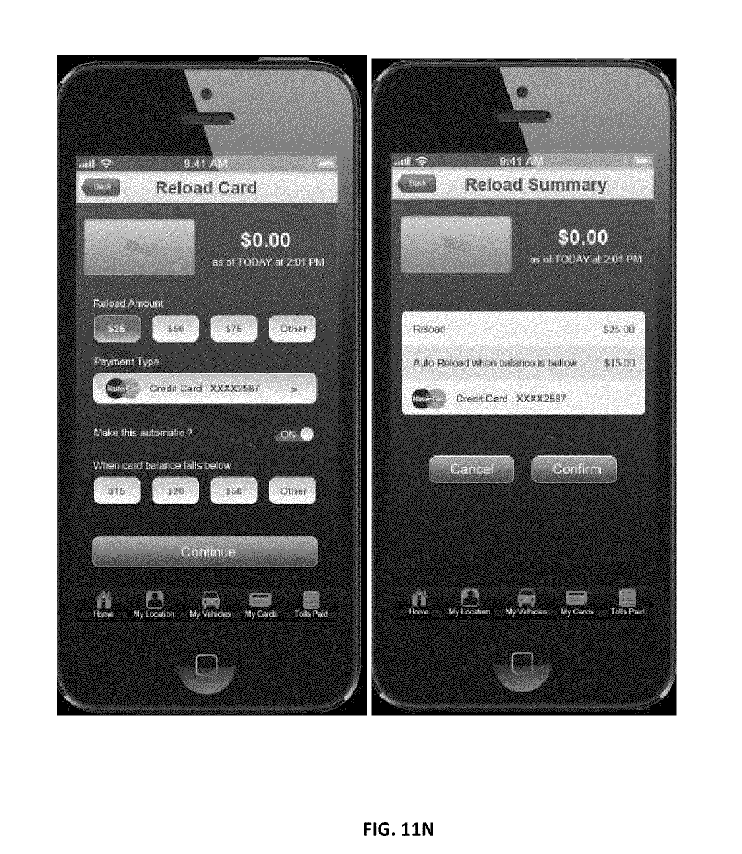

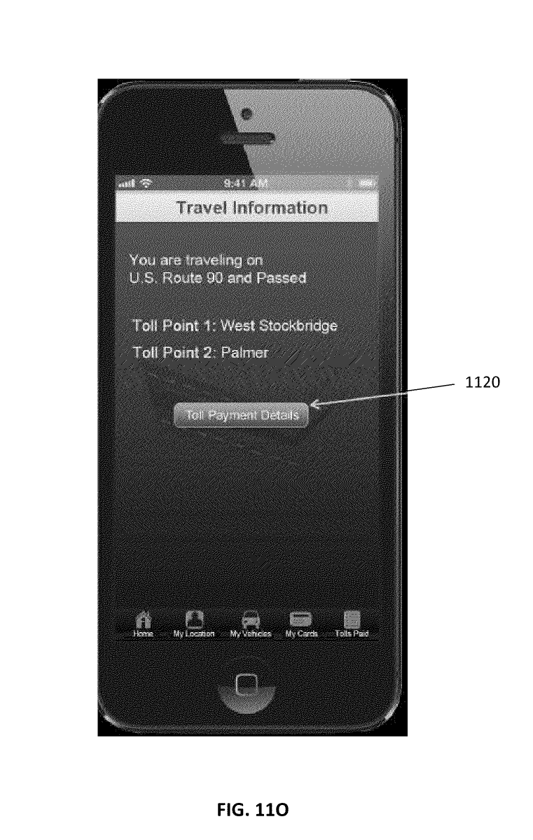

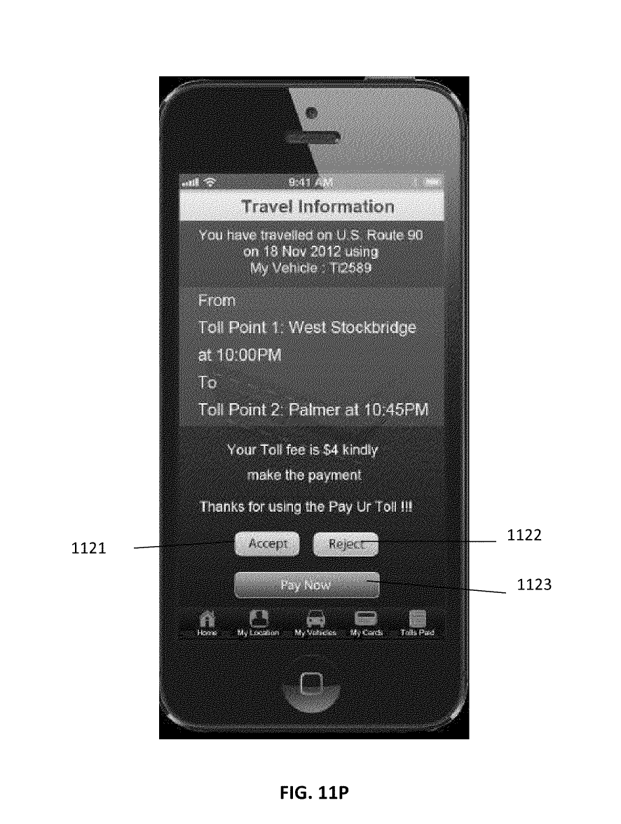

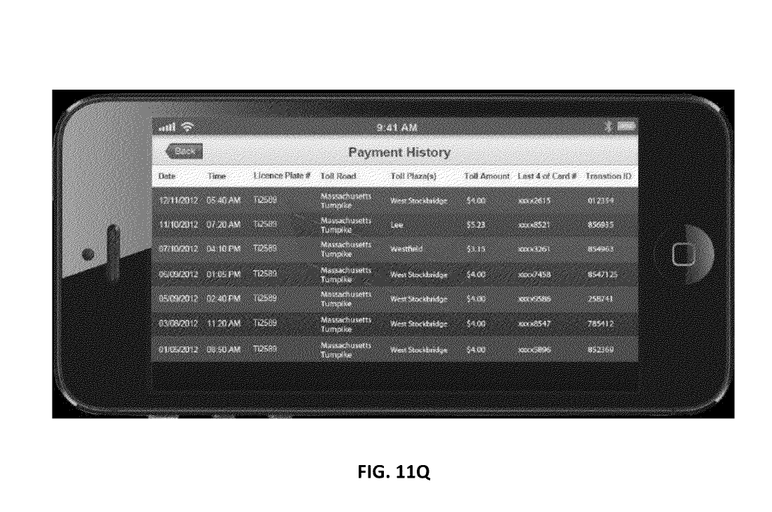

FIGS. 11A-11Q illustrate exemplary screenshots depicting various interfaces associated with a mobile device, according to various implementations of the invention. Various instructions such as a mobile application may be downloaded and installed on the mobile device. The instructions when executed by a processor/microprocessor of the mobile device 110 causes the processor/microprocessor to generate various interfaces as depicted in FIGS. 11A-11P, which may be configured to prompt for and receive customer/user information, provide location information, provide toll road information, toll booth/plaza information associated with a particular toll road, payment information, and/or other information. In some implementations of the invention, the mobile application may facilitate communication between the mobile device 110, toll database server 130 and payment server 160, thereby allowing the toll tag device 115 and/or mobile device 110 to be used to process the toll-based payment transaction.

For example, FIGS. 11A-11D depict interfaces which may prompt for and receive customer/user information (for example, personal information, vehicle information, etc.) for registration purposes. Once the user enters the information, the mobile application may validate the information enter and register the user with the mobile application and/or toll database server 130.

FIG. 11E depicts an interface which may display a default page for a registered customer of the mobile application. In some implementations, the default page may include the current GPS location details of the mobile device. In some implementations, the default page may be displayed when the registered customer selects the mobile application to be opened. In some implementations, various icons may be presented (for example, Home, My Location, My Vehicles, My Cards, Tolls Paid), which when selected by the user may display the respective pages associated with the icons. For example, when a user selects the Home icon 1101, the default page may be displayed, when the user selects the “My Location” icon, 1102 the page with the current GPS location may be displayed, when the user selects the “My Vehicles” icon 1103, the page(s) with the list of registered vehicles may be displayed where the user may view/edit previously entered information, when the user selects the “My Cards” icon 1104, the page(s) with a list of registered payment cards may be displayed where the user may view/edit previously entered information, and when the user selects “Tolls Paid” icon 1105, the page(s) when a list of tolls paid may be displayed.

In some implementations, the default page of FIG. 11E may include a “show toll roads” button 1108, which when selected by the user may display the toll roads that are within a particular distance of the mobile device (as shown in FIG. 11F, for example). The mobile application may automatically download the toll road information and toll plaza information (for example, coordinates, location, etc.) based on the current GPS location of the mobile device.

In some implementations, when a particular toll road button, for example U.S. Route 90 button 1110 is selected, a page depicting toll plaza information for the selected toll road may be displayed (as shown in FIG. 11G, for example)

In some implementations, FIG. 11H depicts a home page of the mobile application. When the user selects the home icon and/or a home button, the home page is displayed. When the user selects the settings icon on the home page, the settings page may be displayed, as shown in FIG. 11I. The user may select his/her default page via “My defaults page” tab. In some implementations, selection of any of the personal information, my cards, my vehicles, my billing addresses tabs leads to the respective pages where the user may view/edit earlier entered details. In some implementations, user may select the show toll roads option to be “on” or “off”. The show toll roads button 1108 of FIG. 11E is displayed only if the show toll roads option is selected as “on”. In some implementations, the user may select the auto-payment feature to be “on” or “off”.

FIGS. 11J-11N depict various interfaces associated with entering and managing payment card information. A user may enter select various types of payment cards and may enter payment card information associated with the selected payment card type (as depicted in FIGS. 11J and 11K, for example). In some implementations, a user may select to use a pre-paid payment card. A user may select to reload the pre-paid payment card, as depicted in FIG. 11L. In some implementations, the user may select the reload amount (for example, $25), and payment type, such as credit or debit card, to reload the pre-paid payment card, as depicted in FIG. 11M. In some implementations, the user may select the reload amount, the payment type, and also select the auto-reload option to “on”, wherein the user authorizes the mobile application to reload the pre-paid card by the reload amount when the card balance falls below a particular dollar amount, as depicted in FIG. 11N, for example. In some implementations, the user may select to manage the pre-paid payment card, wherein the user may be provided with options to refresh the balance, view recent transactions, set auto-reload to on or off, etc.

FIG. 11O depicts a page which may display travel information. In some implementations, the page may include a “toll payment details” button 1120, which when selected by the user causes the page of FIG. 11P to be displayed. The page of FIG. 11P displays the toll points passed by the vehicle and the toll charge/toll fee to be paid. The user may accept or reject the toll charge via selection of buttons 1121 and 1122, respectively. When the user selects the “pay now” button 1123, the mobile application communicates with the payment server 160 for the purposes of processing the payment of the toll charge.

FIG. 11Q depicts a page that displays the toll payment history. The toll payment history includes the date, time, license plate number of the vehicle, the toll road traveled on, the toll plaza(s) passed through, the toll charge amount, the last four digits of the payment card used for payment, and/or the transaction identifier.

The foregoing are non-limiting examples associated with various implementations of the invention. Other uses and implementations of system 100 with respect to various system components will be apparent to those skilled in the art based on the description herein.

Implementations of the invention may be made in hardware, firmware, software, or any suitable combination thereof. Implementations of the invention may also be implemented as instructions stored on a machine-readable medium, which may be read and executed by one or more processors. A tangible machine-readable medium may include any mechanism for storing or transmitting information in a form readable by a machine (e.g., a computing device). For example, a tangible machine-readable storage medium may include read only memory, random access memory, magnetic disk storage media, optical storage media, flash memory devices, and other tangible and non-transitory storage media. Intangible machine-readable transmission media may include intangible forms of propagated signals, such as carrier waves, infrared signals, digital signals, and other intangible transmission media. Further, firmware, software, routines, or instructions may be described in the above disclosure in terms of specific exemplary implementations of the invention, and performing certain actions. However, it will be apparent that such descriptions are merely for convenience and that such actions in fact result from computing devices, processors, controllers, or other devices executing the firmware, software, routines, or instructions.

Implementations of the invention may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

What is claimed is:

1. A mobile device for processing a toll-based transaction, comprising:
a processor configuring the mobile device to:
receive a first audio signal from a toll tag device communicably coupled to the mobile device, wherein the audio signal comprises a toll booth identifier identifying a toll plaza;
retrieve, from a memory device, user information in response to the first audio signal;
convert the user information to a second audio signal; and
communicate the second audio signal to the toll tag device for transmission to the toll plaza identified by the toll booth identifier.

2. The mobile device of claim 1, further comprising a headphone jack, wherein the mobile device is communicably coupled to the toll tag device via the headphone jack.

3. The mobile device of claim 1, wherein the user information comprises identification information associated with the user of the mobile device, vehicle information, and mobile device information.

4. A toll tag device for processing toll-based transactions, comprising:
a processor configuring the toll tag device to:
tune to an RF receive frequency associated with a toll booth radio device, wherein the RF receive frequency is identified based on a current GPS location of a mobile device, wherein the toll tag device is communicably coupled to the mobile device;
receive a first RF signal from the toll booth radio device, wherein the first RF signal comprises a toll booth identifier identifying a toll plaza;
convert the first RF signal to an audio signal; and
communicate the audio signal to a mobile device.

5. The toll tag device of claim 4, wherein the RF receive frequency is determined based on a toll booth payment system within which the toll booth radio device operates.

6. The toll tag device of claim 4, wherein the processor further configures the toll tag device to:
receive user information from the mobile device; and
transmit the user information to the toll plaza identified by the toll booth identifier.

7. The toll tag device of claim 6, wherein the processor further configures the toll tag device to:
tune to an RF transmit frequency associated with the toll booth radio device; and
convert the user information to a second RF signal; and
transmit the second RF signal to the toll booth radio device.

8. A mobile device for processing toll-based transactions, comprising:
a processor configuring the mobile device to:
receive a GPS location of the mobile device;
receive location information associated with at least one tolling location;
determine whether the mobile device is within a predetermined distance of the at least one tolling location based on the GPS location of the mobile device;
record a tolling event when the mobile device is within the predetermined distance of the at least one tolling location; and
communicate the tolling event to a server for processing a toll-based transaction.

9. The mobile device of claim 8, wherein the at least one tolling location comprises at least one toll plaza, and wherein the location information comprises toll plaza coordinates associated with the toll plaza.

10. The mobile device of claim 9, wherein the location information comprises toll road coordinates associated with a toll road on which the toll plaza is located.

11. The mobile device of claim 8, wherein the processor configuring the mobile device to receive the location information further configures the mobile device to:
receive location information associated with at least one tolling location within a predetermined distance of the mobile device.

12. The mobile device of claim 8, wherein the processor configuring the mobile device to receive the location information further configures the mobile device to:
receive location information associated with at least one tolling location along a predicted path of travel of the mobile device.

13. The mobile device of claim 8, wherein the processor configuring the mobile device to determine whether the mobile device is within a predetermined distance of the at least one tolling location further configures the mobile device to:
compare the GPS location of the mobile device with the received location information to make the determination.

14. The mobile device of claim 8, wherein the processor configures the mobile device to determine whether the mobile device is within a predetermined distance of the at least one tolling location periodically.

15. The mobile device of claim 8, wherein the processor configures the mobile device to determine whether the mobile device is within a predetermined distance of the at least one tolling location based on an incremental distance travelled by the mobile device.

16. The mobile device of claim 8, wherein the processor configures the mobile device to determine whether the mobile device is within a predetermined distance of the at least one tolling location based on a speed of travel of the mobile device.

17. The mobile device of claim 8, wherein the processor configures the mobile device to determine whether the mobile device is within a predetermined distance of the at least one tolling location based on a trajectory of the mobile device.

18. The mobile device of claim 8, wherein the processor further configuring the mobile device to:
record a first tolling event when the mobile device is within a predetermined distance of a first tolling location, wherein the first tolling event comprises location coordinates associated with the first tolling location; and
record a second tolling event when the mobile device is within a predetermined distance of a second tolling location, wherein the second tolling event comprises location coordinates associated with the second tolling location; and
communicate the first tolling event and the second tolling event to the server.

19. The mobile device of claim 18, wherein the server determines a toll charge based on the first tolling event and the second tolling event.

20. The mobile device of claim 8, wherein the processor configures the mobile device to communicate the tolling event as or after the mobile device passes through the tolling location.
